(19) United States
(12) Patent Application Publication
(10) Pub. No.: US 2016/0126594 A1
(43) Pub. Date: May 5, 2016

(54) NONAQUEOUS ELECTROLYTE SOLUTION AND NONAQUEOUS SECONDARY BATTERY

(71) Applicant: FUJIFILM Corporation, Tokyo (JP)

(72) Inventors: Kunihiko KODAMA, Ashigarakami-gun (JP); Ikuo KINOSHITA, Ashigarakami-gun (JP); Yohei ISHIJI, Ashigarakami-gun (JP); Toshihiko YAWATA, Ashigarakami-gun (JP)

(73) Assignee: FUJIFILM Corporation, Tokyo (JP)

(21) Appl. No.: 14/993,188

(22) Filed: Jan. 12, 2016

Related U.S. Application Data
(63) Continuation of application No. PCT/JP2014/069851, filed on Jul. 28, 2014.

(30) Foreign Application Priority Data
Jul. 29, 2013 (JP) 2013-157191

(51) Int. Cl. H01M 10/0567; H01M 10/0569; H01M 10/42; H01M 10/0525

(52) U.S. Cl. CPC H01M 10/0567; H01M 10/0525; H01M 10/0569; H01M 10/4235; H01M 2300/0025

(57) ABSTRACT

A nonaqueous electrolyte solution including a nonaqueous solvent; an electrolyte; and a combustion inhibitor, in which the combustion inhibitor contains a phosphazene compound, and specific conditions are defined by boiling points of a combustion inhibitor, a boiling point of a solvent, and the like.

### CROSS-REFERENCE TO RELATED APPLICATIONS

This application is a Continuation of PCT International Application No. PCT/JP2014/069851 filed on Jul. 28, 2014, which claims priority under 35 U.S.C. §119 (a) to Japanese Patent Application No. JP2013-157191 filed in Japan on Jul. 29, 2013. Each of the above applications is hereby expressly incorporated by reference, in its entirety, into the present application.

### BACKGROUND OF THE INVENTION

1. Field of the Invention

The invention relates to a nonaqueous electrolyte solution including a nonaqueous solvent and a nonaqueous secondary battery using the same.

2. Description of the Related Art

A lithium ion secondary battery can realize a great energy density in charging and discharging, compared with a lead acid battery or a nickel-cadmium battery. Due to these characteristics, applications to portable electronic devices such as cellular phones and notebook computers have become widespread. Accordingly, the development of a battery, particularly, a secondary battery that has a light weight and that can obtain high energy density has progressed as a power supply of a portable electronic device. Further, miniaturization, weight reduction, increase in lifespan, and reliability thereof are strongly required. High reliability is required for use in electric vehicles, electric storage facilities, and the like, which are expected that capacity thereof increases, and thus compatibility between battery performance and reliability is more strongly required.

As an electrolyte solution of a lithium ion secondary battery, a combination of a carbonate-based solvent such as propylene carbonate or diethyl carbonate and an electrolyte salt such as lithium hexafluorophosphate is widely used. This is because these have high conductivity and are potentially stable.

Meanwhile, since a low-molecular-weight flammable organic compound is contained in components, in view of reliability, the application of flame retardancy is important. For the purpose of improvement of these, a technique of including a phosphazene compound in an electrolyte solution is suggested (see JP2005-190873A, WO2010/101179A, JP4458841B, and JP2006-286571A).

### SUMMARY OF THE INVENTION

The techniques disclosed in the patent documents described above are not sufficient, and further the realization of higher flame retardancy is desired. In addition, not only the flame retardancy, but also compatibility among all properties of a battery are necessary, and recently, a battery of which characteristics do not deteriorate even in severe conditions of discharging a large current at a low temperature has been required. Further, it is preferable to appropriately deal with a cathode material that can be used up to a high potential of which the use has progressed. Based on this recognition, formulations for an additive that can deal with the demand described above and the like have been reviewed in many ways. As a result of continuing analysis of examination data, it has been found that the demand is not satisfied in processes of an electrolyte solution specifically disclosed in JP4458841B, and JP2006-286571A above. However, knowledge that sufficient performance improvement is not achieved merely by optimizing a boiling point of a combustion inhibitor and a combination with other elements can achieve an initial improvement in flame retardancy and suppression of deteriorating performance of a battery has been obtained. Specifically, the fact that the requirements can be sufficiently satisfied without exception by defining a relationship between a boiling point of a combustion inhibitor or a chemical structure of the combustion inhibitor and a boiling point of a solvent applied thereto and setting parameters by classification into three aspects has been found.

In view of corresponding problem recognition according to the invention and new knowledge based on the same, a first object of the invention is to provide a nonaqueous electrolyte solution and a secondary battery that can improve flame retardancy while decrease of battery performance is suppressed. A second object is to provide a nonaqueous electrolyte solution and a secondary battery that is appropriate for a battery using a cathode material usable up to a high potential containing Ni and/or Mn and that exhibits excellent performance.

The problems are solved by the following means.

[1] A nonaqueous electrolyte solution including a nonaqueous solvent; an electrolyte; and a combustion inhibitor, in which the combustion inhibitor contains a phosphazene compound, and at least one of Conditions (I) to (III) described below is satisfied:

(I) the nonaqueous solvent contains a solvent having a boiling point of 120° C. or lower, a phosphazene compound X1 having a boiling point x1 (unit: ° C.) under 1 atmospheric pressure and a phosphorus-containing compound Y1 having a boiling point y1 (unit: ° C.) under 1 atmospheric pressure are at least used as combustion inhibitors, and Formula (i) below is satisfied with respect to the boiling points x1 and y1 of the combustion inhibitors,

x1≦120<y1≦220 (i)

(II) a phosphazene compound X2 having a boiling point x2 (unit: ° C.) under 1 atmospheric pressure and a phosphorus-containing compound Y2 having a boiling point y2 (unit: ° C.) under 1 atmospheric pressure are at least used as combustion inhibitors, and Formula (ii) below is satisfied with respect to the boiling points x2 and y2 of the combustion inhibitors and a boiling point a (unit: ° C.) of a solvent A having the lowest boiling point among nonaqueous solvents under 1 atmospheric pressure,

x2≦a<y2≦a+90 (ii)

(III) the nonaqueous solvent contains 20% by volume to 80% by volume of a solvent having a boiling point of 100° C. or lower with respect to all the nonaqueous solvent and contains 1% by mass to 20% by mass of a combustion inhibitor X3 expressed by Formula (X3) below with respect to all the electrolyte solution,

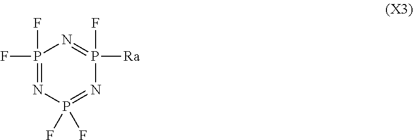

(Ra represents a substituent containing carbon atoms and the number of C—H bonds is 3 or less).

[2] The nonaqueous electrolyte solution according to [1], in which each of the combustion inhibitors Y1 and Y2 is independently selected from a phosphoric acid ester compound, a phosphoric acid amide compound, and a phosphazene compound.
[3] The nonaqueous electrolyte solution according to [1], in which each of the combustion inhibitors X1, X2, X3, Y1, and Y2 independently represents a cyclic phosphazene compound.
[4] The nonaqueous electrolyte solution according to any one of [1] to [3], in which each of Y1 and Y2 independently represents a cyclic phosphazene compound having an amino group.
[5] The nonaqueous electrolyte solution according to any one of [1] to [4], in which the nonaqueous solvent contains 20% by volume to 80% by volume of dimethyl carbonate and/or ethyl methyl carbonate with respect to all the solvent.
[6] The nonaqueous electrolyte solution according to any one of [1] to [5], in which the nonaqueous solvent contains 20% by volume to 80% by volume of dimethyl carbonate with respect to all of a solvent.
[7] The nonaqueous electrolyte solution according to any one of [1], [3], [5], and [6], in which each of at least one of the combustion inhibitors X1, X2, X3, Y1, and Y2 independently represents a cyclic phosphazene compound expressed by Formula (F1) below.

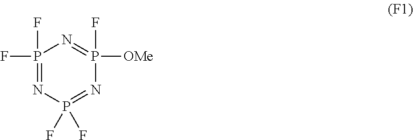 [SMILES: COP1(F)=NP(F)(F)=NP(F)(F)=N1]

[8] The nonaqueous electrolyte solution according to any one of [1] to [7], in which the electrolyte solution further contains at least one selected from an aromatic compound (A), a halogen-containing compound (B), a polymerizable compound (C), a phosphorus-containing compound (D), a sulfur-containing compound (E), a silicon-containing compound (F), a nitrile compound (G), a metal complex compound (H), and an imide compound (I).
[9] A nonaqueous secondary battery including a cathode; an anode; and the nonaqueous electrolyte solution according to any one of [1] to [8].
[10] The nonaqueous secondary battery according to [9], in which an active material of the cathode contains Ni and/or Mn atoms.
[11] The nonaqueous secondary battery according to [9] or [10], in which an active material of the anode is one selected from carbon, Si, titanium, and tin.
[12] A method of using the secondary battery according to any one of [9] to [11] for charging and discharging, in which the secondary battery is used at a positive electrode potential (based on Li/Li⁺) of 4.3 V or greater.

In the specification, when there are plural substituents or linking groups denoted by specific reference symbols, or plural substituents and the like (the number of substituents is also defined in the same manner) are simultaneously or alternatively defined, respective substituents and the like may be identical to or different from each other. In addition, if the plural substituents and the like come close to each other, the substituents and the like may form a ring by being bonded to each other or being condensed. When a ring is formed, a hetero linking group described below may be incorporated.

The nonaqueous electrolyte solution according to the invention exhibits an excellent effect of improving flame retardancy while suppressing capacity deterioration in a low temperature condition and/or large current discharging, in the secondary battery including this nonaqueous electrolyte solution. Further, the nonaqueous electrolyte solution is appropriate for a battery using a cathode material usable up to a high potential containing Ni and/or Mn, if necessary, and exhibits the excellent effect described above.

Characteristics described above, other characteristics, and advantages of the invention are clearly revealed with reference to the descriptions below and accompanying drawings.

### BRIEF DESCRIPTION OF THE DRAWINGS

FIG. 1 is a sectional view schematically illustrating a mechanism of a lithium secondary battery according to a preferred embodiment according to the invention.

FIG. 2 is a sectional view schematically illustrating a specific configuration of the lithium secondary battery according to the preferred embodiment according to the invention.

### DESCRIPTION OF THE PREFERRED EMBODIMENTS

The nonaqueous electrolyte solution according to the invention contains a nonaqueous solvent, an electrolyte, and a combustion inhibitor, the combustion inhibitor contains a phosphazene compound, and a relationship between the nonaqueous solvent and the combustion inhibitor satisfies any one condition of (I) to (III) described below. The reason for the excellent effects above being exhibited due to defining these parameters relating to these relationships between the nonaqueous solvent and the combustion inhibitor is assumed to be as follows.

When discharging is performed in a low temperature condition and/or at a large current in a nonaqueous electrolyte solution, it is advantageous to use a solvent having a low viscosity, in view of battery performance. This is because ion conductivity increases, and thus the deterioration of a capacity is suppressed by using this solvent. At a low temperature and under more severe discharging conditions such as large current discharging, the effect of the low viscosity solvent is more notable. However, a solvent having a low viscosity generally has a low boiling point and a low flash point, at the same time. Particularly, a solvent having a low boiling point (for example, 120° C. or lower) among solvents generally used in a lithium ion battery has a low flash point (for example, less than 25° C.) in many cases. From this point of view, according to the invention, a boiling point of a solvent, a boiling point of a combustion inhibitor, and a chemical structure are defined by performing classification into specific ranges of Conditions (I) to (III) below (in a definition other than the conditions described above, it is difficult to specify solutions to the problems described above without an excess or a deficiency).

Specifically, in Condition (I), use of the solvent having a low boiling point is defined, and, in this case, a combustion inhibitor having a low boiling point that evaporates in association with the low boiling point solvent and exhibits an ignition suppression effect is employed. Meanwhile, a combustion inhibitor having a high boiling point in a not too high range is employed such that the inhibition of fire spreading can be effectively exhibited. An example of an advantage of using a low boiling point solvent includes exhibiting an excellent effect of maintaining and improving battery performance.

In Condition (II), in a system to which 2 types of combustion inhibitor are applied, a boiling point of a combustion inhibitor thereof is set in a specific range around the boiling point of the solvent, such that an ignition suppression effect and a combustion inhibition effect are exhibited in a well balanced manner, and satisfactory flame retardancy are realized. Further, if this condition is satisfied, an effect is exhibited of maintaining and improving the battery performance.

In Condition (III), when a solvent having a low boiling point is used, a combustion inhibitor with a chemical structure having a high ignition suppression effect is chosen and defined. Accordingly, together with showing higher flame retardancy, if this condition is satisfied, an excellent effect in maintaining and improving battery performances as an advantage of using a low boiling point solvent is exhibited.

Among the conditions, Condition (III) is particularly appropriate for being used in combination with a cathode material that can be used up to a high potential and when performing charging and discharging at a high potential of a positive electrode potential of 4.3 V or greater (more preferably 4.4 V or greater). Specifically, generally when performance deterioration due to decomposition of an additive in such a high potential condition is notable, an electrolyte solution of Condition (III) is stable, and satisfactory performance can be maintained. It is considered that this is because, in addition to a high oxidation potential of the phosphazene compound X3, the stability thereof can be further improved by combination with a predetermined nonaqueous solvent.

### First Embodiment

### Condition (I)

According to the embodiment, the nonaqueous solvent contains a solvent having a boiling point of 120° C. or lower. Further, as combustion inhibitors contained therein, at least a phosphazene compound X1 having a boiling point x1 under 1 atmospheric pressure and a phosphorus-containing compound Y1 having a boiling point y1 under 1 atmospheric pressure are used. At this point, as the combustion inhibitors, another compound may be used. In addition, in this specification, the phosphazene compound is included as a phosphorus-containing compound.

With respect to the combustion inhibitor, the following relationship is satisfied.

x1≦120<y1≦220 (i)

The range of the boiling point x1 of the phosphazene compound X1 is 120° C. or lower, preferably 30° C. or higher, more preferably 40° C. or higher, and particularly preferably 50° C. or higher.

The definition of the boiling point y1 on an upper limit side is defined as 220° C. or lower, but 200° C. or lower is preferable, 190° C. or lower is more preferable, 175° C. or lower is further preferable, and 160° C. or lower is particularly preferable. The lower limit of y1 exceeds 120° C., but 125° C. or higher is preferable, 130° C. or higher is more preferable, and 140° C. or higher is particularly preferable.

As the nonaqueous solvent (hereinafter, referred to as the solvent L) having a boiling point of 120° C. or lower in Embodiment (I), a carbonate solvent such as dimethyl carbonate (boiling point of 90° C.) and ethyl methyl carbonate (boiling point of 108° C.), an ether solvent such as tetrahydrofuran (boiling point of 66° C.), tetrahydropyran (boiling point of 88° C.), 1,3-dioxolane (boiling point of 75° C.), 1,4-dioxane (boiling point of 101° C.), and 1,2-dimethoxyethane (boiling point of 85° C.), an ester solvent such as methyl acetate (boiling point of 58° C.), ethyl acetate (boiling point of 77° C.), methyl propionate (boiling point of 79° C.), ethyl propionate (boiling point of 99° C.), methyl difluoroacetate (boiling point of 85° C.), and methyl trifluoroacetate (boiling point of 61° C.), a nitrile solvent such as acetonitrile (boiling point of 82° C.), propionitrile (boiling point of 97° C.), and isobutyronitrile (boiling point of 108° C.), and an aromatic solvent such as benzene (boiling point of 80° C.), fluorobenzene (boiling point of 85° C.), and hexafluorobenzene (boiling point of 81° C.) are preferable. Among these, a carbonate solvent, particularly, dimethyl carbonate, and ethyl methyl carbonate are further preferable, since large current discharging characteristics are excellent. In addition, a boiling point in this specification is a value at 1 atmospheric pressure unless particularly described otherwise.

It is preferable that the concentration of the nonaqueous solvent L is 20% by volume or greater with respect to all the solvent, since the effect of the invention is remarkably exhibited, 50% by volume or greater is more preferable, and 60% by volume or greater is particularly preferable. The upper limit is not particularly limited, and the content of the nonaqueous solvent L may be 100% by volume (all of the solvent). However, in view of an effect of combination with a high boiling point solvent, 90% by volume or less is preferable, 80% by volume or less is more preferable, and 70% by volume or less is particularly preferable.

The range of the boiling point of the nonaqueous solvent L is 120° C. or lower, 50° C. or higher is preferable, 70° C. or higher is more preferable, and 80° C. or higher is particularly preferable.

The solvent (the solvent L) having a boiling point of 120° C. or lower may be combined with a solvent (solvent H) having a boiling point greater than 120° C., and the ratio of the solvent H is preferably 20 parts by mass or greater, more preferably 30 parts by mass or greater, and particularly preferably 40 parts by mass or greater with respect to 100 parts by mass of the solvent L. The definition on the upper limit side is preferably 500 parts by mass or less, more preferably 400 parts by mass or less, and particularly preferably 300 parts by mass or less. Examples of the solvent H include diethyl carbonate (boiling point of 127° C.), ethylene carbonate (boiling point of 238° C.), propylene carbonate (boiling point of 242° C.), and gamma-butyrolactone (boiling point of 204° C.).

The boiling point of the solvent H exceeds 120° C., and the definition thereof on the upper limit side is preferably 300° C. or lower, more preferably 270° C. or lower, and particularly preferably 250° C. or lower. The boiling point difference between the solvent H and the solvent L is not particularly limited, but the difference thereof (ΔT=boiling point Th of the solvent H−boiling point Tl of the solvent L) is preferably 5° C. to 200° C., more preferably 100° C. to 180° C., and particularly preferably 120° C. to 160° C. At this point, if there are 3 or more types of solvent, the lowest boiling point thereof is defined as Tl, and the highest boiling point thereof is defined as Th.

Examples for the specific solvents are as follows.

EC−DMC=238−90=148

EC−EMC=238−108=130

EC−DEC=238−127=111

EC: Ethyl carbonate

DMC: Dimethyl carbonate

EMC: Ethyl methyl carbonate

DEC: Diethyl carbonate

As X1, a cyclic phosphazene compound expressed by Formula (X1-1) or (X1-2) is more preferable.

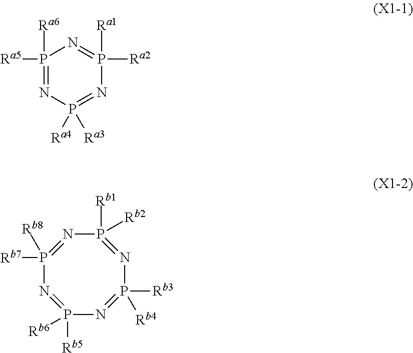

Each of R^{a1} to R^{a6} independently represents a univalent group, and a halogen atom (preferably, fluorine atom), an alkyl group (the number of carbon atoms is preferably 1 to 12, more preferably 1 to 6, and particularly preferably 1 to 3), an alkoxy group (the number of carbon atoms is preferably 1 to 12, more preferably 1 to 6, and particularly preferably 1 to 3), and an —NCO group are preferable. R^{a1} to R^{a6} may be identical to or different from each other.

It is preferable that at least 4 of R^{a1} to R^{a6} are fluorine atoms, and it is further preferable that at least 5 are fluorine atoms.

Each of R^{b1} to R^{b8} independently represents a univalent group, and a halogen atom (preferably, a fluorine atom), an alkyl group (the number of carbon atoms is preferably 1 to 12, more preferably 1 to 6, and particularly preferably 1 to 3), an alkoxy group (the number of carbon atoms is preferably 1 to 12, more preferably 1 to 6, and particularly preferably 1 to 3), and an —NCO group are preferable. R^{b1} to R^{b8} may be identical to or different from each other.

It is preferable that at least 6 of R^{b1} to R^{b8} are fluorine atoms, and it is further preferable that at least 7 are fluorine atoms.

According to this embodiment, specific examples of the phosphazene compound X1 of which a boiling point is 120° C. or lower under 1 atmospheric pressure are shown below. Among these, PN-1, 3, 4, 17, and 18 are particularly preferable.

| | | | | |
|---|---|---|---|---|
| Structure | 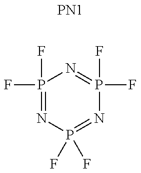 | 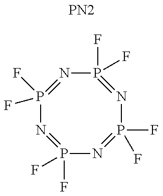 | 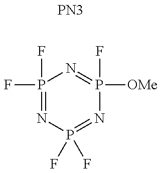 [SMILES: COP1(F)=NP(F)(F)=NP(F)(F)=N1 ; "PN3"] | 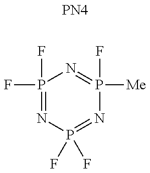 [SMILES: "PN4" ; CP1(F)=NP(F)(F)=NP(F)(F)=N1] |
| Boiling point | 51° C. | 86° C. | 110° C. | 105° C. |

| | | | |
|---|---|---|---|
| Structure | 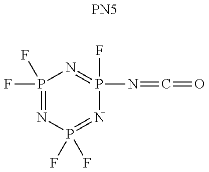 [SMILES: "PN5" ; O=C=NP1(F)=NP(F)(F)=NP(F)(F)=N1] | 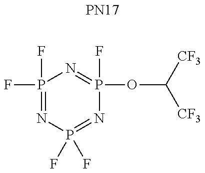 [SMILES: "PN17" ; FC(F)(F)C(OP1(F)=NP(F)(F)=NP(F)(F)=N1)C(F)(F)F] | 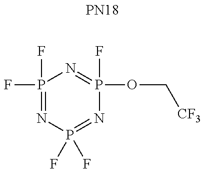 [SMILES: "PN18" ; FC(F)(F)COP1(F)=NP(F)(F)=NP(F)(F)=N1] |
| Boiling point | 100° C. | 114° C. | 118° C. |

The boiling point (° C.) is a measured value at 1 atmospheric pressure or a calculated value for a boiling point at 1 atmospheric pressure.

As the phosphorus-containing compound Y1, a compound not having an ionic bond in a molecule (phosphorus-containing anionic compound) is preferable. It is preferable that the phosphorus-containing compound Y1 is selected from a phosphoric acid ester compound, a phosphoric acid amide compound, and a phosphazene compound. In addition, the phosphoric acid ester compound and the phosphoric acid amide compound in this specification have a meaning of not only including a compound (derivative) having a phosphoric acid structure, but also widely including a compound (derivative) having a phosphonic acid structure, a compound (derivative) having a phosphinic acid structure, and a compound (derivative) having a phosphine oxide structure.

As the phosphoric acid ester compound that forms the phosphorus-containing compound Y1, (Y1-1) described below is preferable, and as the phosphoric acid amide compound, a compound expressed by (Y1-2) is preferable.

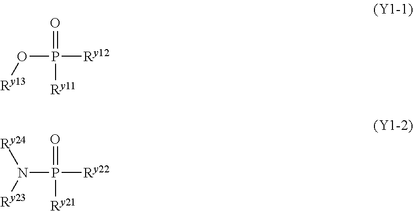

Each of R^{y11}, and R^{y12} independently represents a univalent group or a hydrogen atom. As the univalent group, an alkyl group that may have a fluorine atom (the number of carbon atoms is preferably 1 to 12, the number of carbon atoms is more preferably 1 to 6, the number of carbon atoms is particularly preferably 1 to 3, and a methyl group, an ethyl group, a trifluoromethyl group, and a 2,2,2-trifluoroethyl group are more preferable), and an alkoxy group that may have a fluorine atom (the number of carbon atoms is preferably 1 to 12, the number of carbon atoms is more preferably 1 to 6, the number of carbon atoms is particularly preferably 1 to 3, and a methoxy group, an ethoxy group, a trifluoromethoxy group, a 2,2,2-trifluoroethoxy group, and a 1,1,1,3,3,3-hexafluoroisopropoxy are more preferable) are preferable. Among these, R^{y11} and R^{y12} are preferably alkoxy groups that may have fluorine atoms.

As R^{y13}, an alkyl group that may have a fluorine atom (the number of carbon atoms is preferably 1 to 12, the number of carbon atoms is more preferably 1 to 6, the number of carbon atoms is particularly preferably 1 to 3, a methyl group, a trifluoromethyl group and a 2,2,2-trifluoroethyl group are more preferable) and an alkenyl group that may have a fluorine atom (the number of carbon atoms is preferably 2 to 12, the number of carbon atoms is more preferably 2 to 6, and a vinyl group and an allyl group are more preferable) are preferable. R^{y11} to R^{y13} may be identical to or different from each other. In addition, in the range in which the effect of the invention is exhibited, a substituent T to be described below may be included.

R^{y21} and R^{y22} are univalent groups or hydrogen atoms. As a univalent group, an alkyl group that may have a fluorine atom (the number of carbon atoms is preferably 1 to 12, more preferably 1 to 6, and particularly preferably 1 to 3, and a methyl group, an ethyl group, a trifluoromethyl group, and a 2,2,2-trifluoroethyl group are more preferable), and an alkoxy group that may have a fluorine atom (the number of carbon atoms is preferably 1 to 12, more preferably 1 to 6, and particularly preferably 1 to 3, and a methoxy group, an ethoxy group, a trifluoromethoxy group, and a 2,2,2-trifluoroethoxy group are more preferable) are preferable.

R^{y23} and R^{y24} are univalent groups, and an alkyl group that may have a fluorine atom (the number of carbon atoms is preferably 1 to 12, more preferably 1 to 6, particularly preferably 1 to 3, and a methyl group, an ethyl group, a trifluoromethyl group, and a 2,2,2-trifluoroethyl group are more preferable) is preferable. R^{y21} to R^{y24} may be identical to or different from each other. In addition, in the range that exhibits the effect of the invention, the substituent T to be described below may be included.

Specific compounds of Y1-1 and Y1-2 are shown below. Among these, Y1-1d, Y1-1e, and Y1-2a are particularly preferable.

| Structure | 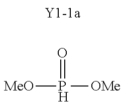 | 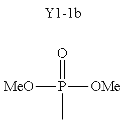 | 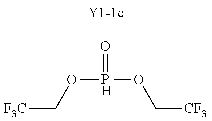 | 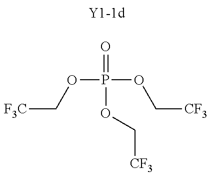 [SMILES: O=P(OCC(F)(F)F)(OCC(F)(F)F)OCC(F)(F)F] |
|---|---|---|---|---|
| Boining point | 170° C. | 181° C. | 183° C. | 190° C. |
| Structure | 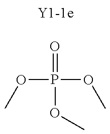 | 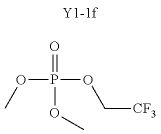 | 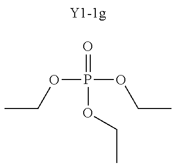 | 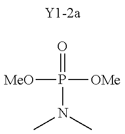 |
| Boiling point | 197° C. | 210° C. | 216° C. | 185° C. |

The boiling point (° C.) is a measured value at 1 atmospheric pressure or a calculated value for a boiling point under 1 atmospheric pressure.

As the phosphazene compound that forms the phosphorus-containing compound Y1, a compound expressed by any one of (Y1-3) and (Y1-4) below is preferable.

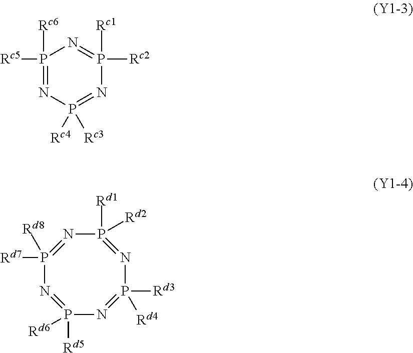

Each of R^{c1} to R^{c6} is independently a univalent group, a halogen atom (preferably, a fluorine atom), an alkyl group (the number of carbon atoms is preferably 1 to 12, more preferably 1 to 6, and particularly preferably 1 to 3), an alkoxy group (the number of carbon atoms is preferably 1 to 12, more preferably 1 to 6, and particularly preferably 1 to 3), a dialkylamino group (the number of carbon atoms is preferably 2 to 12 and more preferably 2 to 6), and a —NCO group are preferable, an alkoxy group and a dialkylamino group are more preferable, and a dialkylamino group is particularly preferable since combustion inhibition is excellent.

It is preferable that at least 4 of R^{c1} to R^{c6} are fluorine atoms, and it is further preferable that at least 5 are fluorine atoms. R^{c1} to R^{c6} may be identical to or different from each other. In addition, in the range that exhibits the effect of the invention, the substituent T to be described below may be included.

Each of R^{d1} to R^{d8} is independently a univalent group, a halogen atom (preferably, a fluorine atom), an alkyl group (the number of carbon atoms is preferably 1 to 12, more preferably 1 to 6, and particularly preferably 1 to 3), an alkoxy group (the number of carbon atoms is preferably 1 to 12, more preferably 1 to 6, and particularly preferably 1 to 3), a dialkylamino group (the number of carbon atoms is preferably 2 to 12 and more preferably 2 to 6), and an —NCO group are preferable, an alkoxy group and a dialkylamino group are more preferable, and a dialkylamino group is particularly preferable.

It is preferable that at least 6 of R^{d1} to R^{d8} are fluorine atoms, and it is further preferable that at least 7 are fluorine atoms. R^{d1} to R^{d8} may be identical to or different from each other. In addition, in the range that exhibits the effect of the invention, the substituent T to be described below may be included.

When the phosphorus-containing compound Y1 is a phosphazene compound, specific examples as below can be provided. Among these, PN-6 to PN-11, 13, and 15 are preferable, and PN-9, 10, and 13 having an amino group are particularly preferable.

| Structure | 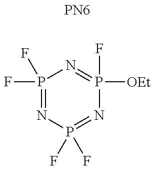 [SMILES: "PN6" ; CCOP1(F)=NP(F)(F)=NP(F)(F)=N1] | 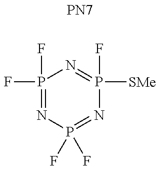 [SMILES: "PN7" ; CSP1(F)=NP(F)(F)=NP(F)(F)=N1] | 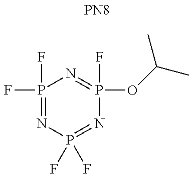 | 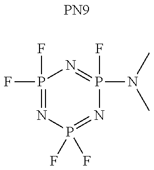 |
|---|---|---|---|---|
| Boiling point | 125° C. | 130° C. | 137° C. | 142° C. |
| Structure | 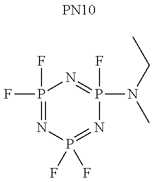 | 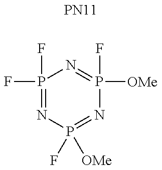 [SMILES: "PN11" ; COP1(F)=NP(F)(F)=NP(F)(OC)=N1] | 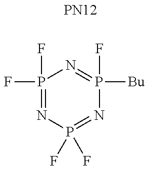 | 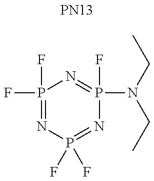 [SMILES: "PN13" ; CCN(CC)P1(F)=NP(F)(F)=NP(F)(F)=N1] |
| Boiling point | 151° C. | 156° C. | 157° C. | 160° C. |
| | Structure | 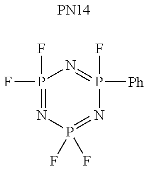 [SMILES: "PN14" ; FP1(F)=NP(F)(F)=NP(F)(c2ccccc2)=N1] | 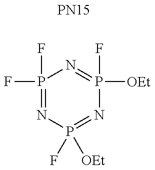 [SMILES: "PN15" ; CCOP1(F)=NP(F)(F)=NP(F)(OCC)=N1] | 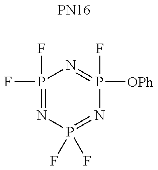 [SMILES: "PN16" ; FP1(F)=NP(F)(F)=NP(F)(Oc2ccccc2)=N1] |
| | Boiling point | 185° C. | 194° C. | 213° C. |

The addition amount of X1 and Y1 is preferably 0.1% by mass or greater, more preferably 0.5% by mass or greater, and particularly preferably 1% by mass or greater with respect to all of an electrolyte solution (including electrolyte) in total including the phosphazene compound X1 and the phosphorus-containing compound Y1. Meanwhile, the definition on the upper limit side is preferably 20% by mass or less, more preferably 10% by mass or less, and particularly preferably 7% by mass or less. A mass ratio of the phosphazene compound X1 and the phosphorus-containing compound Y1 is preferably X1/Y1=10/1 to 1/10, more preferably 5/1 to 1/5, further preferably 3/1 to 1/3, and particularly preferably 2/1 to 1/2.

According to the embodiment, a difference between the boiling point x1 of the phosphazene compound X1 and the boiling point y1 of the phosphorus-containing compound Y1 is not particularly limited, but (y1−x1) is preferably 10° C. or higher, more preferably 20° C. or higher, and particularly preferably 30° C. or higher. As the definition on the upper limit side, 200° C. or lower is preferable, 150° C. or lower is more preferable, and 120° C. or lower is particularly preferable.

An absolute value |Tl−x1| of a difference between the boiling point Tl of the solvent L and the boiling point x1 of the phosphazene compound X1 is preferably 0° C. or higher. The definition on the upper limit side is preferably 80° C. or lower, more preferably 50° C. or lower, and particularly preferably 30° C. or lower.

An absolute value |Th−Y1| of a difference between the boiling point Th of the solvent H and the boiling point y1 of the phosphorus-containing compound Y1 is preferably 10° C. or higher, more preferably 20° C. or higher, and particularly preferably 50° C. or higher. The definition on the upper limit side is preferably 180° C. or lower, more preferably 150° C. or lower, and particularly preferably 130° C. or lower.

At this point, if there are 3 or more types of phosphorus-containing compound, the lowest boiling point thereof is defined as x1, and the highest boiling point is defined as y1. In the same manner, if there are 3 or more types of solvent, the lowest boiling point is defined as Tl, and the highest boiling point is defined as Th. Hereinafter, unless described otherwise, when 3 or more types of matter become targets, the highest value and the lowest value of the boiling points become comparison targets.

### Second Embodiment

### Condition (II)

According to this embodiment, as combustion inhibitors, at least a phosphazene compound X2 having a boiling point x2 under 1 atmospheric pressure and a phosphorus-containing compound Y2 having a boiling point y2 under 1 atmospheric pressure are used. Further, with respect to the boiling points x2 and y2 of the combustion inhibitors, and a boiling point a of a solvent A having a lowest boiling point of the nonaqueous solvent under 1 atmospheric pressure, Formula (ii) below is satisfied.

x2≦a<y2≦a+90 Formula (ii)

It is preferable that Formula (ii) is preferably Formula (iia)

a−40≦x2≦a<y2≦a+70 Formula (iia)

In this embodiment, a high combustion inhibition effect and satisfactory battery performance can be obtained by using the phosphazene compound X2 having a lower boiling point (preferably a boiling point close to the boiling point a) than the boiling point a of the solvent A having the lowest boiling point and the phosphorus-containing compound Y2 having a high boiling point, as defined in the formula above.

The addition amount of X2 and Y2 is preferably 0.1% by mass or greater, more preferably 0.5% by mass or greater, and particularly preferably 1% by mass or greater, in total including the phosphazene compound X2 and the phosphorus-containing compound Y2, with respect to all the electrolyte solution (including electrolyte). Meanwhile, the definition on the upper limit side is preferably 20% by mass or less, more preferably 10% by mass or less, and particularly preferably 7% by mass or less. The weight ratio between the phosphazene compound X2 and the phosphorus-containing compound Y2 is preferably X2/Y2=10/1 to 1/10, more preferably 5/1 to 1/5, further preferably 3/1 to 1/3, and particularly preferably 2/1 to 1/2.

As the phosphazene compound X2 and the phosphorus-containing compound Y2, compounds having a relationship of Formula (ii) with respect to the boiling point a of the solvent A having the lowest boiling point among the nonaqueous solvents are selected. The solvent A can be widely selected from low boiling point solvents L and high boiling point solvents H. Among these, dimethyl carbonate (boiling point of 90° C.), ethyl methyl carbonate (boiling point of 108° C.), and diethyl carbonate (boiling point of 127° C.) are preferable, and dimethyl carbonate and ethyl methyl carbonate are further preferable, since large current discharging characteristics are excellent. With respect to the range of the boiling point, the boiling point a of the solvent A is preferably in the range of 60° C. to 160° C., more preferably in the range of 70° C. to 130° C., and particularly preferably in the range of 85° C. to 120° C.

If the solvent A has a boiling point of 100° C. or lower (for example, in the case of dimethyl carbonate), the phosphazene compound X2 is preferably PN-1 and 2, and the phosphorus-containing compound Y2 is preferably PN-3 to PN-13, PN-17, and PN-18.

If the solvent A has a boiling point greater than 100° C. and 120° C. or lower (for example, in the case of ethyl methyl carbonate), the phosphazene compound X2 is preferably PN-1 to 4, and the phosphorus-containing compound Y2 is preferably PN-5 to PN-15, Y1-1a to Y1-1e, and Y1-2a.

If the solvent A has a boiling point greater than 120° C. (for example, in the case of diethyl carbonate), the phosphazene compound X2 is preferably PN-1 to 6, PN-17, and PN-18, and the phosphorus-containing compound Y2 is preferably PN-7 to PN-16, Y1-1a to Y1-1g, and Y1-2a.

In the second embodiment, the nonaqueous solvent may be 2 or more types of solvent. An example of a combination at this point includes a combination of boiling points of a high boiling point solvent H and a low boiling point solvent L, and a preferable temperature difference thereof is the same as that in Embodiment 1 above.

In the second embodiment, the difference between the boiling point x2 of the phosphazene compound X2 and the boiling point y2 of the phosphorus-containing compound Y2 is not particularly limited, but (y2−x2) is preferably 10° C. or higher, more preferably 20° C. or higher, and particularly preferably 30° C. or higher. The definition on the upper limit side is preferably 200° C. or lower, more preferably 150° C. or lower, and particularly preferably 120° C. or lower.

An absolute value |a−x2| of the difference between the boiling point a of the solvent A and the boiling point x2 of the phosphazene compound X2 is preferably 0° C. or higher. The definition on the upper limit side is preferably 80° C. or lower, more preferably 70° C. or lower, and particularly preferably 40° C. or lower.

### Third Embodiment

### Condition (III)

In this embodiment, the nonaqueous solvent contains 20% by volume to 80% by volume (preferably, 30% by volume to 70% by volume) of the solvent having a boiling point of 100° C. or lower, with respect to all the nonaqueous solvent. In addition, 1% by mass to 20% by mass of a combustion inhibitor X3 expressed by Formula (X3) below is contained with respect to all the electrolyte solution (including electrolyte). The amount of the combustion inhibitor expressed by Formula (X3) below is more preferably 15% by mass or less, further preferably 10% by mass or less, and particularly preferably 7% by mass or less. In Embodiment 3, it is preferable that plural types of combustion inhibitor are not used, and that only one type of combustion inhibitor is used. In this manner, when a combustion inhibitor is used singly, it is meaningful that a compound limited by Formula (X3) below is used, and a particularly notable effect is exhibited. In addition, the electrolyte solution of this embodiment (Condition (III)) exhibits a notable effect in a combination with a cathode material that can be used up to a high potential.

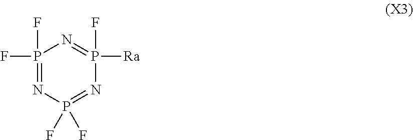

Ra contains a carbon atom and is a substituent of which the number of C—H bonds is 3 or less.

Ra is preferably an organic group having 1 to 3 carbon atoms, and it is more preferable that the number of carbon atoms is 1. Examples of a preferable Ra include -Me, —OMe, —SMe, —CN, —NCO, —NCS, —OCH₂CF₃, —OCF₃, —OCH(CF₃)₃, —OCH₂CF₂CF₃, and —OCH₂CF₂CF₂H, and —OMe, —OCH₂CF₃, and —OCH(CF₃)₃ are particularly preferable. Here, Me represents a methyl group.

With respect to the compound expressed by Formula (X3), a C—H bond content ratio expressed by Formula (ix) below is preferably 0.015 or less. Since the C—H bond promotes combustion, the combustion inhibition effect can be enhanced by decreasing a C—H bond content ratio in a molecule. Particularly, according to the third embodiment, simply in view of the combustion inhibition, a compound having high combustion inhibition performance is applied, and also a compound having physical properties in a cyclic phosphazene structure is selected and combined with a low boiling point solvent in a specific amount such that an excellent combustion inhibition effect is exhibited.

C—H bond content ratio=(the number of C—H bonds in a molecule)/molecular weight Formula (ix)

Hereinafter, preferable specific examples of the compound expressed by Formula (X3) are shown below.

| Structure | 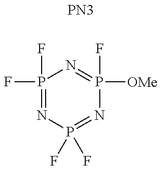 [SMILES: COP1(F)=NP(F)(F)=NP(F)(F)=N1 ; "PN3"] | 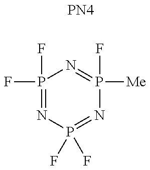 [SMILES: "PN4" ; CP1(F)=NP(F)(F)=NP(F)(F)=N1] | 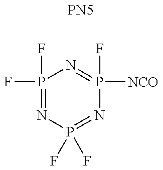 |
|---|---|---|---|
| C—H bond content ratio | 0.0115 | 0.0122 | 0 |
| Structure | 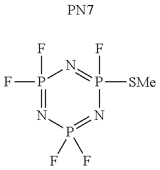 [SMILES: "PN7" ; CSP1(F)=NP(F)(F)=NP(F)(F)=N1] | 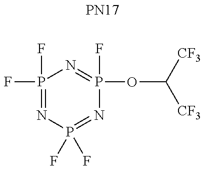 [SMILES: "PN17" ; FC(F)(F)C(OP1(F)=NP(F)(F)=NP(F)(F)=N1)C(F)(F)F] | 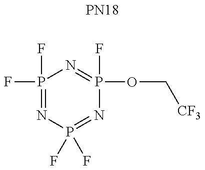 [SMILES: "PN18" ; FC(F)(F)COP1(F)=NP(F)(F)=NP(F)(F)=N1] |
| C—H bond content ratio | 0.0108 | 0.0025 | 0.0061 |

As a solvent having a boiling point of 100° C. or lower in this embodiment, a carbonate solvent such as dimethyl carbonate (boiling point of 90° C.), an ether solvent such as tetrahydrofuran (boiling point of 66° C.), tetrahydropyran (boiling point of 88° C.), 1,3-dioxolane (boiling point of 75° C.), and 1,2-dimethoxyethane (boiling point of 85° C.), an ester solvent such as methyl acetate (boiling point of 58° C.), ethyl acetate (boiling point of 77° C.), methyl propionate (boiling point of 79° C.), ethyl propionate (boiling point of 99° C.), methyl difluoroacetate (boiling point of 85° C.), and methyl trifluoroacetate (boiling point of 61° C.), a nitrile solvent such as acetonitrile (boiling point of 82° C.) and propionitrile (boiling point of 97° C.), and an aromatic solvent such as benzene (boiling point of 80° C.), fluorobenzene (boiling point of 85° C.), and hexafluorobenzene (boiling point of 81° C.) are preferable. Among them, a carbonate solvent is further preferable. In this embodiment, when 20% by volume to 80% by volume (preferably 30% by volume to 70% by volume) of dimethyl carbonate is contained as the solvent having a boiling point of 100° C. or lower with respect to all the nonaqueous solvent, the effect according to the invention becomes more notable.

A solvent having a boiling point greater than 100° C. may be used in combination with the solvent having a boiling point of 100° C. or lower. Examples thereof include ethyl methyl carbonate (boiling point of 108° C.) and the high boiling point solvent H (Embodiment 1) described above.

An absolute value |Tm−x3| of a difference between a boiling point Tm of the solvent which is 100° C. or lower and a boiling point x3 of the compound expressed by Formula (X3) is preferably 0° C. or higher. The definition on the upper limit side is preferably 50° C. or lower, more preferably 40° C. or lower, and particularly preferably 30° C. or lower. If the absolute value of the difference is small, it is preferable since the combustion inhibition effect becomes notable in this specification.

The nonaqueous electrolyte solution according to the invention satisfies one of Conditions (I) to (III) above, more preferably satisfies 2 of (I) to (III), and further preferably satisfies the conditions of (I) and (II), or conditions of (I) and (III).

Here, if matters common to Conditions (I) to (III) above are mentioned, it is preferable that each of the combustion inhibitors Y1 and Y2 is independently selected from a phosphoric acid ester compound, a phosphoric acid amide compound, and a phosphazene compound. Particularly, among these, it is more preferable that each of Y1 and Y2 independently represents a cyclic phosphazene compound having an amino group. If the combustion inhibitors X1, X2, X3, Y1, and Y2 are collectively mentioned, it is preferable that each of the combustion inhibitors X1, X2, X3, Y1, and Y2 independently represents a cyclic phosphazene compound.

(Electrolyte)

It is preferable that the electrolyte used in the electrolyte solution according to the invention is a salt of a metal ion belonging to Groups I and II in the periodic table. The materials thereof are appropriately selected depending on the usage purposes of the electrolyte solution. Examples thereof include a lithium salt, a potassium salt, a sodium salt, a calcium salt, and a magnesium salt. If the electrolyte is used in a secondary battery and the like, a lithium salt is preferable, in view of output. If the electrolyte solution according to the invention is used as a nonaqueous electrolyte solution for a lithium secondary battery, a lithium salt may be selected as a salt of a metal ion. As the lithium salt, a lithium salt that is commonly used in an electrolyte of a nonaqueous electrolyte solution for a lithium secondary battery is preferable, and salts shown below are preferable.

(L-1) Inorganic lithium salt: An inorganic fluoride salt such as LiPF₆, LiBF₄, LiAsF₆, and LiSbF₆; a perhalogenate salt such as LiClO₄, LiBrO₄, and LiIO₄; an inorganic chloride salt such as LiAlCl₄, and the like.

(L-2) Fluorine-containing organic lithium salt: A perfluoroalkanesulfonic acid salt such as LiCF₃SO₃; a perfluoroalkanesulfonyl imide salt such as LiN(CF₃SO₂)₂, LiN(CF₃CF₂SO₂)₂, LiN(FSO₂)₂, and LiN(CF₃SO₂)(C₄F₉SO₂); a perfluoroalkanesulfonyl methide salt such as LiC(CF₃SO₂)₃; a fluoroalkyl fluoride phosphoric acid salt such as Li[PF₅(CF₂CF₂CF₃)], Li[PF₄(CF₂CF₂CF₃)₂], Li[PF₃(CF₂CF₂CF₃)₃], Li[PF₅(CF₂CF₂CF₂CF₃)], Li[PF₄(CF₂CF₂CF₂CF₃)₂], and Li[PF₃(CF₂CF₂CF₂CF₃)₃], and the like

(L-3) Oxalatoborate salt: lithium bis(oxalato)borate, lithium difluorooxalatoborate, and the like

Among these, LiPF₆, LiBF₄, LiAsF₆, LiSbF₆, LiClO₄, Li(Rf¹SO₃), LiN(Rf¹SO₂)₂, LiN(FSO₂)₂, and LiN(Rf¹SO₂)(Rf²SO₂) are preferable, and a lithium imide salt such as LiPF₆, LiBF₄, LiN(Rf¹SO₂)₂, LiN(FSO₂)₂, and LiN(Rf¹SO₂)(Rf²SO₂) is more preferable. Here, Rf¹ and Rf² each represent a perfluoroalkyl group.

In addition, the electrolytes used in the electrolyte solution may be used singly, or 2 or more types thereof may be arbitrarily combined.

It is preferable that the electrolyte (preferably an ion of a metal belonging to Groups I and II in the periodic table or a metal salt thereof) in the electrolyte solution is added in an amount for a preferable salt concentration described in a preparation method of an electrolyte solution. The salt concentration is appropriately selected depending on the usage purpose of the electrolyte solution, but is generally 10% by mass to 50% by mass with respect to the total mass of the electrolyte solution and more preferably 15% by mass to 30% by mass. As a molar concentration, 0.5 M to 1.5 M is preferable. In addition, when the evaluation is performed with a concentration of an ion, the concentration may be estimated in terms of a salt with metal preferably applied.

(Nonaqueous Solvent)

In the nonaqueous electrolyte solution according to the invention, another solvent may be further contained, in addition to the nonaqueous solvent exemplified above. As the used solvent, a non-protonic organic solvent is preferable, and a compound having an ether group, a carbonyl group, an ester group, or a carbonate group is preferable. The compound may have a substituent, and examples thereof include the substituent T described below.

Examples of the organic solvent include ethylene carbonate, propylene carbonate, butylene carbonate, γ-butyrolactone, γ-valerolactone, N,N-dimethylformamide, N-methylpyrrolidinone, N-methyloxazolidinone, N,N′-dimethylimidazolidinone, nitromethane, nitroethane, sulfolane, dimethylsulfoxide, and dimethylsulfoxide phosphate. These may be used singly, or 2 or more types thereof may be used in combination. Among these, at least one type selected from ethylene carbonate, propylene carbonate, and γ-butyrolactone is preferable.

With respect to the nonaqueous solvent, according to Conditions (I) to (III) above, 20% by volume to 80% by volume of dimethyl carbonate and/or ethyl methyl carbonate is preferably contained with respect to all the solvent. Among these, 20% by volume to 80% by volume of dimethyl carbonate is more preferably contained with respect to all the solvent.

(Functional Additive)

It is preferable that various functional additives are contained in the electrolyte solution according to the invention. Examples of the functions exhibited by the additives include an improvement of flame retardancy, an enhancement of cycle characteristics, and an improvement of capacity characteristics. Hereinafter, an example of a functional additive that is preferably applied to the electrolyte according to the invention is provided.

<Aromatic Compound (A)>

Examples of the aromatic compound include a biphenyl compound and an alkyl-substituted benzene compound. The biphenyl compound has a partial structure in which 2 benzene rings are bonded by a single bond, and the benzene rings may have a substituent. A preferable substituent is an alkyl group having 1 to 4 carbon atoms (for example, methyl, ethyl, propyl, and t-butyl), or an aryl group having 6 to 10 carbon atoms (for example, phenyl and naphthyl).

Specifically, examples of the biphenyl compound include biphenyl, o-terphenyl, m-terphenyl, p-terphenyl, 4-methylbiphenyl, 4-ethylbiphenyl, and 4-tert-butylbiphenyl.

The alkyl-substituted benzene compound is preferably a benzene compound substituted with an alkyl group having 1 to 10 carbon atoms, and specific examples thereof include ethylbenzene, isopropylbenzene, cyclohexylbenzene, t-amylbenzene, t-butylbenzene, and tetrahydronaphthalene.

<Halogen-Containing Compound (B)>

As a halogen atom included in the halogen-containing compound, a fluorine atom, a chlorine atom, and a bromine atom are preferable, and a fluorine atom is more preferable. The number of halogen atoms is preferably 1 to 6, and further preferably 1 to 3. As the halogen-containing compound, a carbonate compound substituted with fluorine atoms, a polyether compound having fluorine atoms, and a fluorine-substituted aromatic compound are preferable.

The halogen-substituted carbonate compound may have any one of a chain form and a cyclic form, but in view of ion conductivity, a cyclic carbonate compound having excellent coordinating properties with an electrolyte salt (for example, a lithium ion) is preferable, and a 5-membered ring cyclic carbonate compound is particularly preferable.

Preferable specific examples of the halogen-substituted carbonate compound are shown below. Among these, compounds of Bex1 to Bex4 are preferable, and Bex1 is particularly preferable.

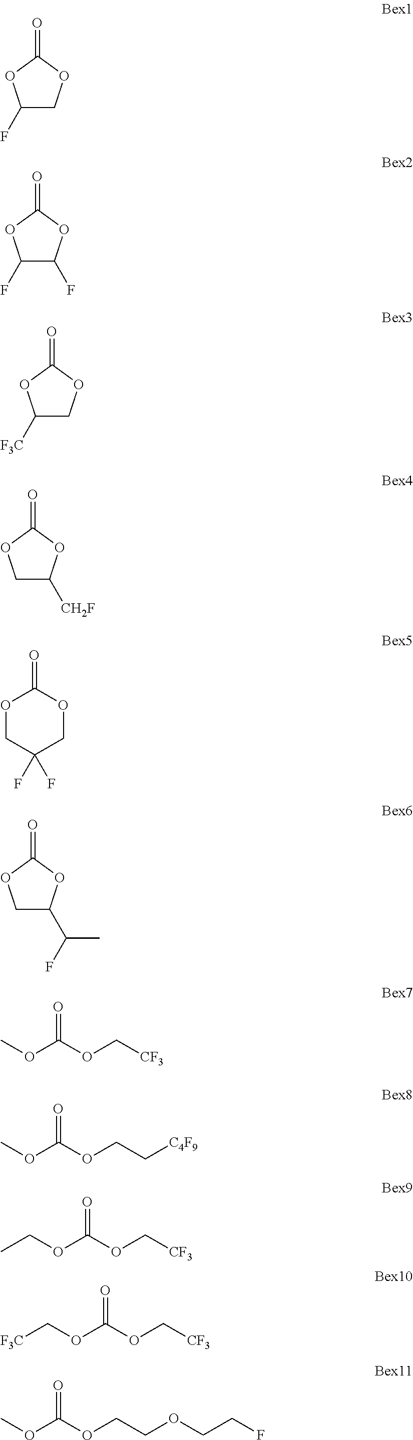

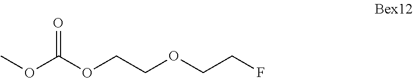

<Polymerizable Compound (C)>

As the polymerizable compound, a compound having a carbon-carbon double bond is preferable, a carbonate compound having a double bond such as vinylene carbonate and vinylethylene carbonate, a compound having a group selected from an acrylate group, a methacrylate group, a cyanoacrylate group, and an α CF₃ acrylate group and a compound having a styryl group are preferable, and a carbonate compound having a double bond or a compound having 2 or more polymerizable groups in a molecule is further preferable.

<Phosphorus-Containing Compound (D)>

The phosphorus-containing compound is a phosphorus-containing compound other than X1 to X3, Y1, and Y2 described above, and a phosphoric acid ester compound and a phosphazene compound are preferable. Preferable examples of the phosphoric acid ester compound include triphenyl phosphate and tribenzyl phosphate. As the phosphorus-containing compound, a compound expressed by Formula (D2) or (D3) below is also preferable.

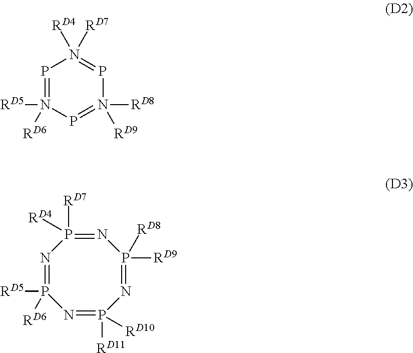

In the formula, R^{D4} to R^{D11} represent univalent substituents. Among the univalent substituents, an alkyl group, an aryl group, an alkoxy group, an acryloxy group, an amino group, a halogen atom such as fluorine, chlorine, and bromine, and the like are preferable. It is preferable that at least one of the substituents R^{D4} to R^{D11} is a fluorine atom, and a substituent formed of an alkoxy group, an amino group, and a fluorine atom is more preferable.

<Sulfur-Containing Compound (E)>

As the sulfur-containing compound, compounds having —SO₂—, —SO₃—, or —OS(═O)O— bonds are preferable, and a cyclic sulfur-containing compound such as propane sultone, propene sultone, and ethylene sulfite, and sulfonic acid esters are preferable.

As the sulfur-containing cyclic compound, compounds expressed by Formulae (E1) and (E2) below are preferable.

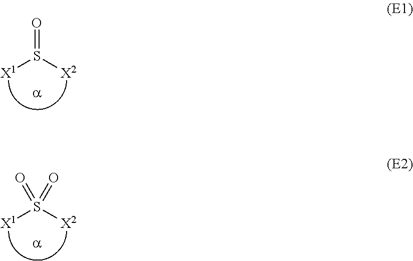

In the formulae, each of X¹ and X² independently represents —O— or —C(Ra)(Rb)—. Here, each of Ra and Rb independently represents a hydrogen atom or a substituent. As the substituent, an alkyl group having 1 to 8 carbon atoms, a fluorine atom, and an aryl group having 6 to 12 carbon atoms are preferable. α represents an atom group that is necessary for forming 5 to 6-membered rings. The skeleton of α may include a sulfur atom, an oxygen atom, or the like, in addition to carbon atoms. α may be substituted, and an example of the substituent include the substituent T, and an alkyl group, a fluorine atom, and an aryl group are preferable.

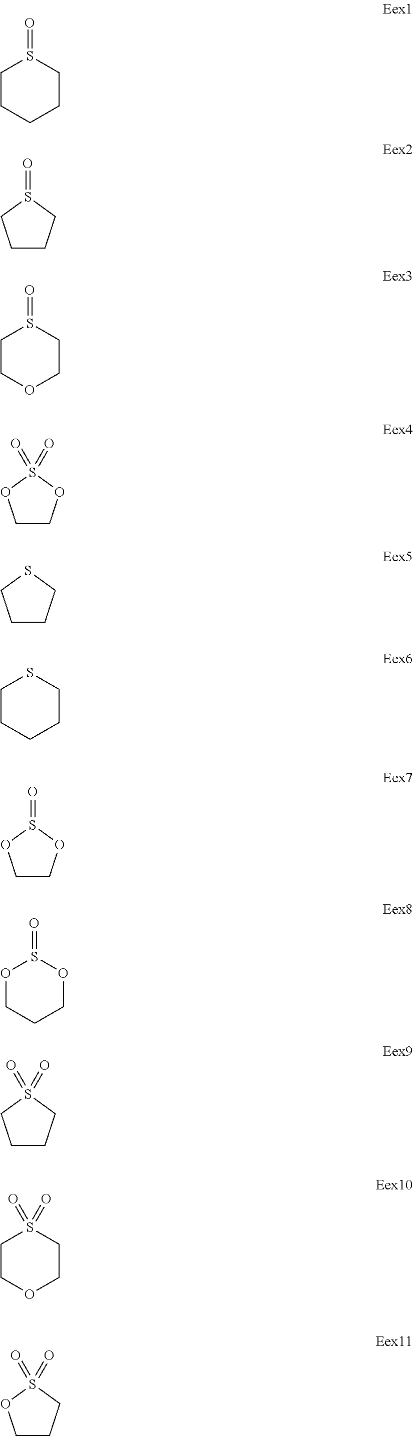

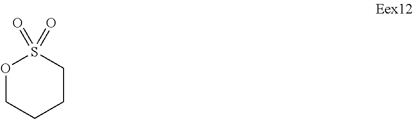

<Silicon-Containing Compound (F)>

As the silicon-containing compound, a compound expressed by Formula (F1) or (F2) is preferable.

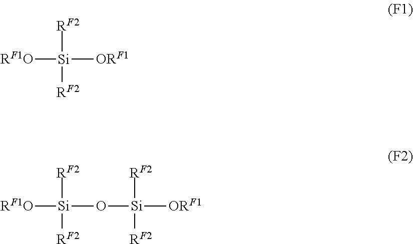

R^{F1} represents an alkyl group, an alkenyl group, an acyl group, an acyloxy group, or an alkoxycarbonyl group.

R^{F2} represents an alkyl group, an alkenyl group, an alkynyl group, or an alkoxy group.

In addition, plural R^{F1}'s and R^{F2}'s included in one formula may be identical to or different from each other.

<Nitrile Compound (G)>

As the nitrile compound, a compound expressed by Formula (G) below is preferable.

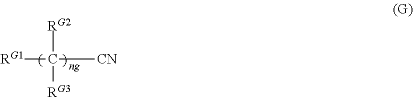

In the formula, each of R^{G1} to R^{G3} independently represents a hydrogen atom, an alkyl group, an alkoxycarbonyl group, an aryloxycarbonyl group, a cyano group, a carbamoyl group, a sulfonyl group, a halogen atom, or a phosphoryl group. As preferable examples of the respective substituents, examples of the substituent T may be referred to. However, it is preferable that, among them, any one or more of R^{G1} to R^{G3} are compounds having plural nitrile groups including cyano groups.

ng represents an integer of 1 to 8.

As specific examples of the compounds expressed by Formula (G), acetonitrile, propionitrile, isobutyronitrile, succinonitrile, malononitrile, glutaronitrile, adiponitrile, 2-methylglutaronitrile, hexane tricarbonitrile, and propane tetracarbonitrile are preferable. Succinonitrile, malononitrile, glutaronitrile, adiponitrile, 2-methylglutaronitrile, hexane tricarbonitrile, and propane tetracarbonitrile are particularly preferable.

<Metal Complex Compound (H)>

As the metal complex compound, a transition metal complex or a rare earth complex is preferable. Among them, complexes expressed by any one of Formulae (H-1) to (H-3) below are preferable.

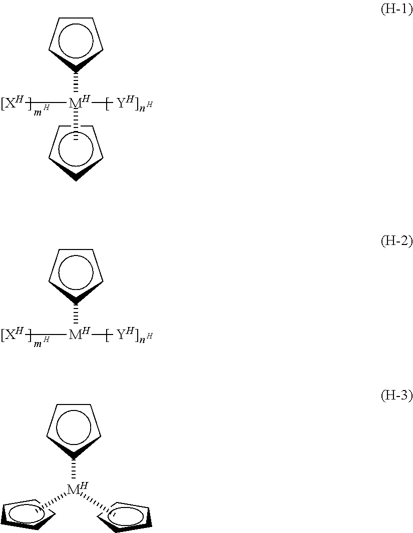

In the formula, each of X^{H} and Y^{H} may be a methyl group, an n-butyl group, a bis(trimethylsilyl)amino group, or a thioisocyanate group, and X^{H} and Y^{H} may be condensed to form a cyclic alkenyl group (butadiene coordination-type metal cycle). In the formula, M^{H} represents a transition element or a rare earth element. Specifically, it is preferable that M^{H} is Fe, Ru, Cr, V, Ta, Mo, Ti, Zr, Hf, Y, La, Ce, Sw, Nd, Lu, Er, Yb, and Gd. m^{H} and n^{H} are integers satisfying 0≦m^{H}+n^{H}≦3. It is preferable that n^{H}+m^{H} is 1 or greater. If n^{H} and m^{H} are 2 or greater, groups defined herein may be different from each other.

It is also preferable that the metal complex compound is a compound having a partial structure expressed by Formula (H-4) below.

M^{H}-(NR^{1H}R^{2H})q^{H} Formula (H-4)

In the formula, M^{H} represents a transition element or a rare earth element, and has the same meaning as in Formulae (H-1) to (H-3).

R^{1H} and R^{2H} represent hydrogen, an alkyl group (a preferable number of carbon atoms is 1 to 6), an alkenyl group (a preferable number of carbon atoms is 2 to 6), an alkynyl group (a preferable number of carbon atoms is 2 to 6), an aryl group (a preferable number of carbon atoms is 6 to 14), a heteroaryl group (a preferable number of carbon atoms is 3 to 6), an alkylsilyl group (a preferable number of carbon atoms is 1 to 6), or halogen. R^{1H} and R^{2H} may be linked to each other. Each of R^{1H} and R^{2H} may be linked to each other to form a ring. Preferable examples of R^{1H} and R^{2H} include examples of the substituent T described below. Among these, a methyl group, an ethyl group, and a trimethylsilyl group are preferable.

q^{H} is an integer of 1 to 4, and an integer of 2 to 4 is preferable. 2 or 4 is further preferable. When q^{H} is 2 or greater, plural groups defined therein may be identical to or different from each other.

It is also preferable that the metal complex compound is a compound expressed by any one of formulae below.

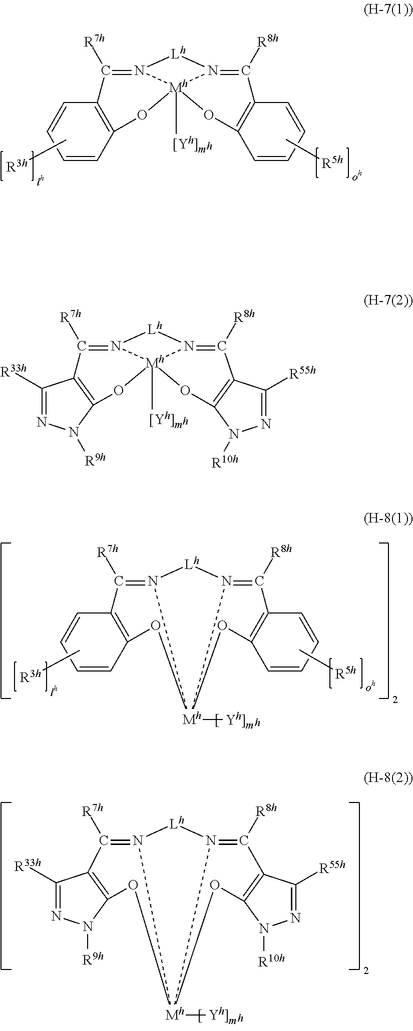

M^{h}

Central metal M^{h} is particularly preferably Ti, Zr, ZrO, Hf, V, Cr, Fe, and Ce and most preferably Ti, Zr, Hf, V, and Cr.

R^{3h}, R^{5h}, R^{7h} to R^{10h}

These represent substituents. Among these, an alkyl group, an alkoxy group, an aryl group, an alkenyl group, and a halogen atom are preferable, an alkyl group having 1 to 6 carbon atoms, an alkoxy group having 1 to 6 carbon atoms, an aryl group having 6 to 12 carbon atoms, and an alkenyl group having 2 to 6 carbon atoms are more preferable, and methyl, ethyl, propyl, isopropyl, isobutyl, t-butyl, perfluoromethyl, methoxy, phenyl, and ethenyl are particularly preferable.

R^{33h}, R^{55h}

R^{33h} and R^{55h} represent hydrogen atoms or substituents for R^{3h}.

Y^{h}

Y^{h} is preferably an alkyl group having 1 to 6 carbon atoms or a bis(trialkylsilyl)amino group, and more preferably a methyl group or a bis(trimethylsilyl)amino group.

l^{h}, m^{h}, o^{h}

l^{h}, m^{h}, and o^{h} are integers of 0 to 3, and an integer of 0 to 2 is preferable. When l^{h}, m^{h}, or o^{h} is 2 or greater, the plural structural portions defined therein may be identical to or different from each other.

L^{h}

L^{h} is preferably an alkylene group and an arylene group, a cycloalkylene group having 3 to 6 carbon atoms and an arylene group having 6 to 14 carbon atoms are more preferable, and cyclohexylene and phenylene are further preferable.

<Imide Compound (I)>

As the imide compound, in view of oxidation resistance, a sulfonimide compound having a perfluoro group is preferable, and specific examples include a perfluoro sulfonimide lithium compound.

Specific examples of imide compounds include the following structures, and Cex1 and Cex2 are more preferable.

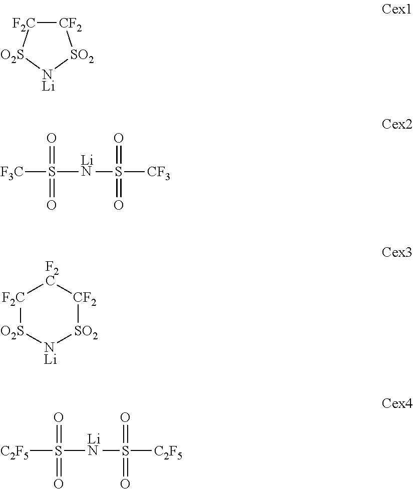

In addition to the above, at least one selected from a negative film-forming agent, a flame retardant, and an overcharge inhibitor may be contained in the electrolyte solution according to the invention. The percentage content of these functional additives in the nonaqueous electrolyte solution is not particularly limited, but each ratio of the functional additives is preferably 0.001% by mass to 10% by mass with respect to the total nonaqueous electrolyte solution (including the electrolyte). Abnormality due to overcharging can be inhibited or capacity maintenance characteristics and cycle characteristics after storage in a high temperature can be improved by adding these compounds.

The exemplary compounds described above may have arbitrary substituents T.

Examples of the substituent T include the following.

Examples are an alkyl group (preferably an alkyl group having 1 to 20 carbon atoms, for example, methyl, ethyl, isopropyl, t-butyl, pentyl, heptyl, 1-ethylpentyl, benzyl, 2-ethoxyethyl, and 1-carboxymethyl), an alkenyl group (preferably an alkenyl group having 2 to 20 carbon atoms, for example, vinyl, allyl, and oleyl), an alkynyl group (preferably an alkynyl group having 2 to 20 carbon atoms, for example, ethynyl, butadiynyl, and phenylethynyl), a cycloalkyl group (preferably a cycloalkyl group having 3 to 20 carbon atoms, for example, cyclopropyl, cyclopentyl, cyclohexyl, and 4-methylcyclohexyl), an aryl group (preferably an aryl group having 6 to 26 carbon atoms, for example, phenyl, 1-naphthyl, 4-methoxyphenyl, 2-chlorophenyl, and 3-methylphenyl), a hetero ring group (preferably a hetero ring group having 2 to 20 carbon atoms, also a hetero ring group of a 5 or 6-membered ring having at least one of an oxygen atom, a sulfur atom, or a nitrogen atom is preferable, and examples thereof include 2-pyridyl, 4-pyridyl, 2-imidazolyl, 2-benzimidazolyl, 2-thiazolyl, and 2-oxazolyl), an alkoxy group (preferably an alkoxy group having 1 to 20 carbon atoms, for example, methoxy, ethoxy, isopropyloxy, and benzyloxy), an aryloxy group (preferably an aryloxy group having 6 to 26 carbon atoms, for example, phenoxy, 1-naphthyloxy, 3-methylphenoxy, and 4-methoxyphenoxy), an alkoxycarbonyl group (preferably an alkoxycarbonyl group having 2 to 20 carbon atoms, for example, ethoxycarbonyl and 2-ethylhexyloxycarbonyl), an amino group (preferable examples thereof include an amino group having 0 to 20 carbon atoms, an alkylamino group, and an arylamino group, and, for example, amino, N,N-dimethylamino, N,N-diethylamino, N-ethylamino, and anilino), a sulfamoyl group (preferably a sulfamoyl group having 0 to 20 carbon atoms, for example, N,N-dimethylsulfamoyl and N-phenylsulfamoyl), an acyl group (preferably an acyl group having 1 to 20 carbon atoms, for example, acetyl, propionyl, butyryl, and benzoyl), an acyloxy group (preferably an acyloxy group having 1 to 20 carbon atoms, for example, acetyloxy and benzoyloxy), a carbamoyl group (preferably a carbamoyl group having 1 to 20 carbon atoms, for example, N,N-dimethylcarbamoyl and N-phenylcarbamoyl), an acylamino group (preferably an acylamino group having 1 to 20 carbon atoms, for example, acetylamino and benzoylamino), an alkylthio group (preferably an alkylthio group having 1 to 20 carbon atoms, for example, methylthio, ethylthio, isopropylthio, and benzylthio), an arylthio group (preferably an arylthio group having 6 to 26 carbon atoms, for example, phenylthio, 1-naphthylthio, 3-methylphenylthio, and 4-methoxyphenylthio), an alkyl or arylsulfonyl group (preferably an alkyl or arylsulfonyl group having 1 to 20 carbon atoms, for example, methylsulfonyl, ethylsulfonyl, and benzenesulfonyl), a hydroxyl group, a cyano group, and a halogen atom (for example, a fluorine atom, a chlorine atom, a bromine atom, an iodine atom), more preferably an alkyl group, an alkenyl group, an aryl group, a hetero cyclic group, an alkoxy group, an aryloxy group, an alkoxycarbonyl group, an amino group, an acylamino group, a hydroxyl group or a halogen atom, and particularly preferably an alkyl group, an alkenyl group, a hetero ring group, an alkoxy group, an alkoxycarbonyl group, an amino group, an acylamino group or a hydroxyl group.

In addition, these respective groups provided as the substituent T may be further substituted with the substituent T above.

When a compound, a substituent•linking group, or the like includes an alkyl group•an alkylene group, an alkenyl group•an alkenylene group, and the like, these may have a cyclic form or a chain form, may have a straight chain form or a branched form, and may be or may not be substituted. In addition, when an aryl group, a hetero ring group, or the like is included, these may be single rings or condensed rings, and may be or may not be substituted, in the same manner.

In addition, in the range that exhibits the effect of the invention, the respective substituents defined in this specification may be substituted with the linking group L below interposed therebetween. For example, an alkyl group•an alkylene group, an alkenyl group˜an alkenylene group, and the like may further have a following hetero linking group interposed therebetween in the structure.

As the linking group L, a hydrocarbon linking group [an alkylene group having 1 to 10 carbon atoms (more preferably having 1 to 6 carbon atoms and further preferably 1 to 3 carbon atoms), an alkenylene group having 2 to 10 carbon atoms (more preferably having 2 to 6 carbon atoms, more preferably 2 to 4 carbon atoms), an arylene group having 6 to 22 carbon atoms (more preferably having 6 to 10 carbon atoms)], a hetero linking group [a carbonyl group (—CO—), an ether group (—O—), a thioether group (—S—), an imino group (—NR^{N}—), an imine linking group (R^{N}—N═C< and —N═C(R^{N})—)], or a linking group obtained by combining these is preferable. In addition, if a condensed ring is formed, the hydrocarbon linking group may be linked to appropriately form a double bond or a triple bond. As the formed ring, a 5-membered ring or a 6-membered ring is preferable. As the 5-membered ring, a nitrogen-containing 5-membered ring is preferable, and examples of the compound that forms the ring include pyrrole, imidazole, pyrazole, indazole, indole, benzimidazole, pyrrolidine, imidazolidine, pyrazolidine, indoline, carbazole, or derivatives thereof. Examples of the 6-membered ring include piperidine, morpholine, piperazine, or derivatives thereof. In addition, if an aryl group and a hetero ring group are included, these rings may be a single ring or a condensed ring and may be or may not be substituted, in the same manner.

R^{N} is a hydrogen atom or a substituent. As the substituent, an alkyl group (the number of carbon atoms is preferably 1 to 24 and more preferably 1 to 12), an alkenyl group (the number of carbon atoms is preferably 2 to 24 and more preferably 2 to 12), an alkynyl group (the number of carbon atoms is preferably 2 to 24 and more preferably 2 to 12), an aryl group having 6 to 10 carbon atoms, and an aralkyl group having 7 to 11 carbon atoms are preferable.

In this specification, the number of atoms that form a linking group is preferably 1 to 36, more preferably 1 to 24, further preferably 1 to 12, and particularly preferably 1 to 6. The number of linking atoms in the linking group is preferably 10 or less and more preferably 8 or less. The lower limit is 1 or greater. The number of linking atoms above refers to a minimum number of atoms that are positioned in a path that connects certain structural portions and participate in the connection. For example, in the case of —CH₂—C(═O)—O—, the number of atoms that configure a linking group is 6, but the number of linking atoms is 3.

Specific examples of the combination of the linking groups include the following. Examples thereof include an oxycarbonyl group (OCO), a carbonate group (OCOO), an amide group (CONH), an urethane group (NHCOO), an urea group (NHCONH), an (oligo)alkyleneoxy group having 1 to 20 carbon atoms (—(Lr—O—)x-: x is an integer of 1 or greater, hereinafter in the same manner), a carbonyl(oligo)oxyalkylene group having 2 to 20 carbon atoms (—CO—(O—Lr)x-), a carbonyloxy(oligo)alkyleneoxy group having 2 to 20 carbon atoms (—COO—(Lr—O—)x-), an (oligo)alkyleneimino group having 1 to 20 carbon atoms (—(Lr—NR^{N}—)x), an alkylene(oligo)iminoalkylene group having 2 to 20 carbon atoms (—Lr—(NR^{N}—Lr—)x-), and a carbonyl(oligo)iminoalkylene group having 2 to 20 carbon atoms (—CO—(NR^{N}—Lr—)x-).

Lr is preferably an alkylene group having 1 to 6 carbon atoms and more preferably an alkylene group having 1 to 3 carbon atoms. Plural Lr's or R^{N}'s, and x's may not be the same.

### [Preparation Method of Electrolyte Solution]

The nonaqueous electrolyte solution according to the invention is prepared in a well-known method by dissolving the respective components described above in the nonaqueous electrolyte solution solvent including an example in which a lithium salt is used as a salt of a metal ion.

According to the invention, the expression “nonaqueous” means not substantially including water, and a very small amount of water may be included in a range not inhibiting the effect of the invention. In consideration of obtaining satisfactory characteristics, the concentration of water is preferably 200 ppm (based on mass) or less, more preferably 100 ppm or less, and further preferably 20 ppm or less. The lower limit value is not particularly limited, but in consideration of inevitable mixture, 1 ppm or greater is practical. The viscosity of the electrolyte solution according to the invention is not particularly limited, but at 25° C., the viscosity is preferably 10 mPa·s to 0.1 mPa·s and more preferably 5 mPa·s to 0.5 mPa·s.

<Method of Measuring Viscosity>

The viscosity in this specification refers to a value measured by the following method. 1 mL of a sample is put into a rheometer (CLS 500) and is measured by using a Steel Cone (all, manufactured by TA Instruments) having a diameter of 4 cm/2°. The sample is kept warm at a starting temperature measured in advance, until a temperature becomes constant, and the measurement starts thereafter. The measurement temperature is 25° C.

[Secondary Battery]

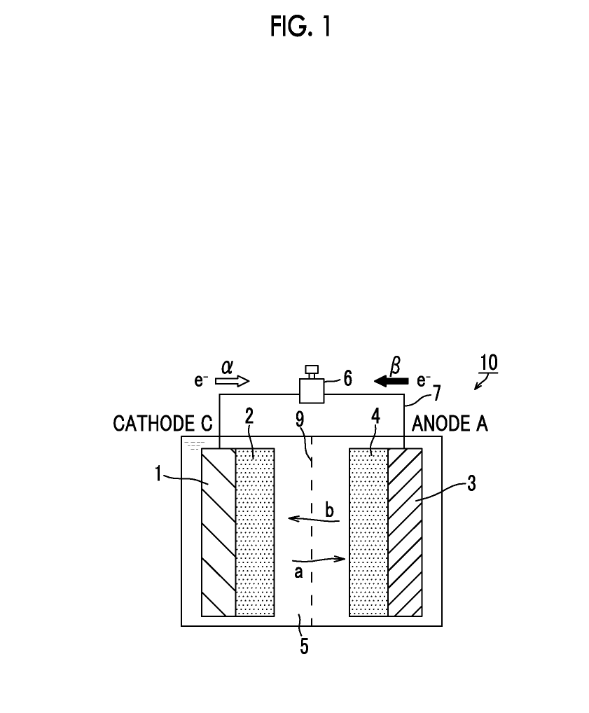

According to the invention, a nonaqueous secondary battery containing the nonaqueous electrolyte solution is preferable. As a preferred embodiment, the lithium ion secondary battery is described with reference to FIG. 1 schematically illustrating the mechanism thereof. A lithium ion secondary battery 10 according to this embodiment includes an electrolyte solution 5 for the nonaqueous secondary battery according to the invention, a cathode C (a cathode collector 1 and a cathode active material layer 2) that can insert and discharge lithium ions, and an anode A (an anode collector 3, an anode active material layer 4) that can insert and discharge or dissolve and deposit lithium ions. In addition to these essential members, in consideration of the purpose of using the battery and the form of the potentials, the nonaqueous secondary battery may be configured to include a separator 9 that is arranged between the cathode and the anode, a collecting terminal (not illustrated), and an exterior housing (not illustrated), and the like. If necessary, a protection element may be mounted on at least one of an internal portion of the battery or an outer portion of the battery. With this structure, transfer a and b of lithium ions in the electrolyte solution 5 occurs, charging a and discharging 13 are performed, and driving or condensation may be performed via an operation mechanism 6 via circuit wiring 7. Hereinafter, the configurations of the lithium secondary battery according to the preferred embodiment of the invention are described in detail.

(Battery Form)

The battery form to which the lithium secondary battery according to the embodiment is applied is not particularly limited, and examples thereof include a bottomed cylindrical shape, a bottomed rectangular shape, a thin shape, a sheet shape, and a paper shape. In addition, the battery form may be an atypical shape such as a horseshoe shape or a comb shape, in consideration of a built-in system or equipment. Among these, in view of effectively discharging heat inside the battery to the outside, a rectangular shape such as a sheet shape or a bottomed rectangular shape that has at least one relatively flat surface and having a large area is preferable.

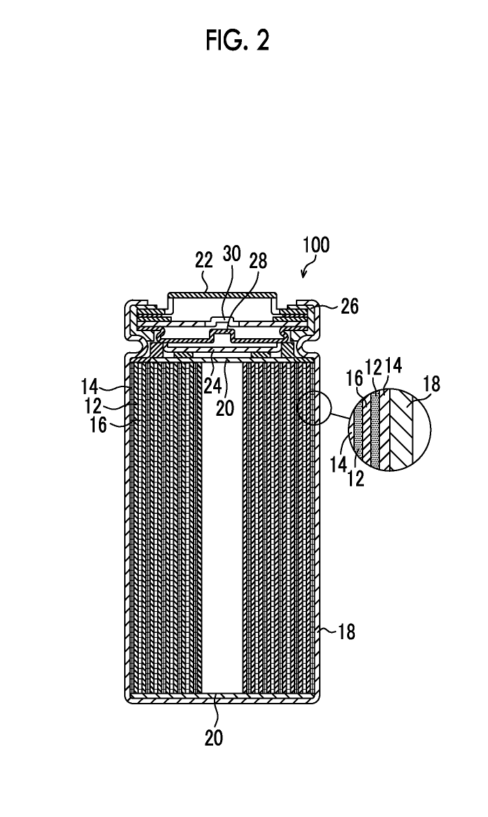

In a bottomed cylindrical battery, an external area with respect to a filled power generating element becomes small, and thus it is preferable to design the battery to cause the Joule heat generated due to the internal resistance to effectively escape to the outside at the time of charging and discharging. In addition, it is preferable to design the battery to increase a filling ratio of a material having high thermal conductivity and decrease temperature distribution in the inside portion. FIG. 2 is a diagram illustrating an example of a bottomed cylindrical lithium secondary battery 100. The battery is the bottomed cylindrical lithium secondary battery 100 in which a cathode sheet 14 and an anode sheet 16 overlapping a separator 12 interposed therebetween are wound and which is stored in an external can 18.

In the bottomed rectangular shape, a value of a ratio 2S/T of twice an area S (the product of a width and a height in external dimensions excluding a terminal area, unit: cm²) of the largest surface to a thickness T (unit: cm) in a battery external shape is preferably 100 or greater and more favorably 200 or greater. If the size of the maximum surface is increased, even if the battery is a battery having a high output and a large capacity, heat dissipation efficiency at the time of abnormal heating can be increased together with improvement of characteristics such as cycle characteristics and high temperature storage. Therefore, it is possible to prevent the battery from being in a state of a so-called “valve action” described below.

(Members Configuring a Battery)

With reference to FIG. 1, the lithium secondary battery according to this embodiment includes the electrolyte solution 5, electrode mixtures C and A of the cathode and the anode, and a basic member 9 of the separator. Hereinafter, these respective members are described below.

(Electrode Composite Material)

The electrode composite material is formed by applying a dispersion material such as an active material, a conductive agent, a binding agent, a filler, and the like to a collector (electrode substrate). In the lithium battery, it is preferable that a cathode mixture of which an active material is a cathode active material and an anode mixture of which an active material is an anode active material are used. Subsequently, respective components in a dispersion material (composition for electrode) that configures the electrode composite material are described.

Cathode Active Material

It is preferable that a transition metal oxide is used in the cathode active material. Among these, it is preferable that a transition element M^{a} (1 or more element selected from Co, Ni, Fe, Mn, Cu, and V) is included. In addition, a mixture element M^{b} (an element in Group 1 (Ia) in the periodic table of metals other than lithium, an element in Group 2 (IIa), Al, Ga, In, Ge, Sn, Pb, Sb, Bi, Si, P, B, and the like) may be mixed in. Examples of this transition metal oxide include specific transition metal oxides including those expressed by any one of Formulae (MA) to (MC) below, or V₂O₅, MnO₂, and the like as other transition metal oxide. A particle-shaped cathode active material may be used as the cathode active material. Specifically, it is possible to use a transition metal oxide that can reversibly insert•discharge lithium ions, but it is preferable to use the specific transition metal oxides described above.

As the transition metal oxide, an oxide including the transition element M^{a} is suitably included. At this point, a mixture element M^{b} (preferably Al) and the like may be mixed. The mixture amount is preferably 0 mol % to 30 mol % with respect to the amount of the transition metal. The transition metal oxide obtained by performing mixing and synthesizing such that a molar ratio of Li/M^{a} becomes 0.3 to 2.2 is more preferable.

[Transition Metal Oxide Expressed by Formula (MA) (Laminar Rock Salt Structure)]

For the lithium containing transition metal oxide, among them, oxides expressed by the following formula are preferable.

LiₐM¹O_{b} (MA)

In the formula, M¹ has the same meaning as Ma above. a represents 0 to 1.2, preferably 0.1 to 1.15, and further preferably 0.6 to 1.1. b represents 1 to 3 and preferably 2. A portion of M¹'s may be substituted with the mixture element M^{b}. The transition metal oxide expressed by Formula (MA) above typically has a laminar rock salt structure.

It is more preferable that this transition metal oxide is an oxide expressed by the respective formulae below.

Li_{g}CoOₖ (MA-1)

Li_{g}NiOₖ (MA-2)

Li_{g}MnOₖ (MA-3)

Li_{g}CoⱼNᵢ₋ⱼOₖ (MA-4)

Li_{g}NiⱼMnᵢ₋ⱼOₖ (MA-5)

Li_{g}CoⱼNiᵢAl₁₋ⱼ₋ᵢOₖ (MA-6)

Li_{g}CoⱼNiᵢMn₁₋ⱼ₋ᵢOₖ (MA-7)

Here, g has the same meaning as a above. j represents 0.1 to 0.9. i represents 0 to 1. However, 1−j−i is 0 or greater. k has the same meaning as b above. Specific examples of the transition metal compound are LiCoO₂ (lithium cobalt oxide [LCO]), LiNi₂O₂ (lithium nickel oxide), LiNi_{0.85}Co_{0.01}Al_{0.05}O₂ (lithium nickel cobalt aluminum oxide [NCA]), LiNi_{0.33}Co_{0.33}Mn_{0.33}O₂ (lithium nickel manganese cobalt oxide [NMC]), and LiNi_{0.5}Mn_{0.5}07 (lithium manganese nickel oxide).

The transition metal oxides expressed by Formula (MA) partially overlap. However, if the notation is changed, the following may also be provided as preferable examples.

(i) Li_{g}NiₓMn_{y}Co_{z}O₂ (x>0.2, y>0.2, z≧0, and x+y+z=1)

Typical Transition Metal Oxides:

Li_{g}Ni_{1/3}Mn_{1/3}CO_{1/3}O₂

Li_{g}Ni_{1/2}Mn_{1/2}O₂

(ii) Li_{g}NiₓCo_{y}Al_{z}O₂ (x>0.7, y>0.1, 0.1>z≧0.05, and x+y+z=1)

Typical Transition Metal Oxide:

Li_{g}Ni_{0.8}Co_{0.15}Al_{0.05}O₂

[Transition Metal Oxide Expressed by Formula (MB) (Spinel-Type Structure)]

For the lithium containing transition metal oxide, among these, a transition metal oxide expressed by Formula (MB) below is also preferable.

Li_{c}M²₂O_{d} (MB)

In the formula, M² has the same meaning as Ma above. c represents 0 to 2, preferably 0.1 to 1.15, and more preferably 0.6 to 1.5. d represents 3 to 5, and preferably 4.

The transition metal oxide expressed by Formula (MB) is more preferably a transition metal oxide expressed by respective formulae below.

LiₘMn₂Oₙ (MB-1)

LiₘMnₚAl₂₋ₚOₙ (MB-2)

LiₘMnₚNi₂₋ₚOₙ (MB-3)

m has the same meaning as c. n has the same meaning as d. p represents 0 to 2. Specific examples of the transition metal compound are LiMn₂O₄ and LiMn_{1.5}Ni_{0.5}O₄.

Preferable examples of the transition metal oxide expressed by Formula (MB) include the following.

LiCoMnO₄ (a)

Li₂FeMn₃O₈ (b)

Li₂CuMn₃O₈ (c)

Li₂CrMn₃O₈ (d)

Li₂NiMn₃O₈ (e)

In view of a high capacity and a high output, among the above, an electrode including Ni is further preferable.

[Transition Metal Oxide Expressed by Formula (MC)]

It is preferable that lithium containing transition metal phosphorus oxides are used as the lithium containing transition metal oxide. Among them, phosphorus oxides expressed by Formula (MC) below are preferable.

LiₑM³(PO₄)_{f} (MC)

In the formula, e represents 0 to 2, preferably 0.1 to 1.15, and more preferably 0.5 to 1.5. f represents 1 to 5 and preferably 0.5 to 2.

M³ above represents one or more types of element selected from V, Ti, Cr, Mn, Fe, Co, Ni, and Cu. M³ above may be substituted with another metal such as Ti, Cr, Zn, Zr, and Nb, in addition to the mixture element M^{b}. Specific examples thereof include an olivine-type iron phosphate salt such as LiFePO₄ and Li₃Fe₂(PO₄)₃, iron pyrophosphates such as LiFeP₂O₇, cobalt phosphates such as LiCoPO₄, and a monoclinic nasicon-type vanadium phosphate salt such as Li₃V₂(PO₄)₃ (lithium vanadium phosphate).

In addition, a, c, g, m, and e values above indicating the composition of Li are values that change according to charging and discharging and are typically evaluated as values in a stable state when Li is contained. In Formulae (a) to (e) above, as specific values, the composition of Li is indicated, but this also changes according to an operation of the battery.

Among these, according to the invention, it is preferable to use a cathode active material containing Ni and/or Mn atoms, and it is further preferable to use a cathode active material containing both of Ni and Mn atoms.

As particularly preferable specific examples of the cathode active material, the following are provided.

LiNi_{0.33}Co_{0.33}Mn_{0.33}O₂

LiNi_{0.6}Co_{0.2}Mn0.1O₂

LiNi_{0.8}Co_{0.1}Mn_{0.1}O₂

LiNi_{0.5}CO_{0.3}Mn_{0.2}O₂

LiNi_{0.5}Mn_{0.5}O₂

LiNi_{0.5}Mn_{1.5}O₄

Since these can be used at a high potential, these are particularly preferable because battery capacity can be increased, and a capacity retention rate is high even if the battery is used at a high potential.

According to the invention, it is preferable that the cathode active material uses a material that can maintain a normal use at a positive electrode potential (based on Li/Li⁺) of 3.5 V or greater, and the positive electrode potential is preferably 3.8 V or greater, more preferably 4 V or greater, particularly preferably 4.25 V or greater, and most preferably 4.3 V or greater. The upper limit is not particularly limited, but 5 V or less is practical. If the positive electrode potential is in the range described above, cycle characteristics and high rate discharging characteristics can be improved.

Here, the expression of maintenance of a normal use means that an electrode material does not deteriorate to become disabled even if charging is performed at the voltage, and this potential is referred to as a normal use potential.

A positive electrode potential (based on Li/LF) at the time of charging and discharging is:

(positive electrode potential)=(negative electrode potential)+(battery voltage). If lithium titanate is used as an anode, a negative electrode potential is 1.55 V. If graphite is used as an anode, a negative electrode potential is 0.1 V. At the time of charging, a battery voltage is observed so as to calculate a positive electrode potential.

The nonaqueous electrolyte solution according to the invention is particularly preferably used in combination with a cathode material that can be used up to a high potential. If the cathode material that can be used up to a high potential is used, cycle characteristics generally greatly decrease, but the nonaqueous electrolyte solution according to the invention has specific combinations set in Conditions (I) to (III) above (particularly, Condition (III)), and thus a satisfactory performances in which a decrease is prevented can be maintained. This point is also advantages and characteristics relating to a preferred embodiment according to the invention.

In the nonaqueous secondary battery according to the invention, the average particle diameter of the cathode active material used is not particularly limited, but is preferably 0.1 μm to 50 μm. The specific surface area is not particularly limited, but is preferably 0.01 m²/g to 50 m²/g in the BET method. In addition, when 5 g of a cathode active material is dissolved in 100 ml of distilled water, the pH of a supernatant is preferably 7 to 12.

In order to cause a cathode active material to have a predetermined particle diameter, a well-known grinding machine or a well-known classifier is used. For example, a mortar, a ball mill, a vibrating ball mill, a vibrating mill, a satellite ball mill, a planetary ball mill, a turning air flow-type jet mill, and a sieve are suitably used. The cathode active material that can be obtained in the baking method above may be used after being cleaned with water, an acidic aqueous solution, an alkaline aqueous solution, or an organic solvent.

The content of the cathode active material is not particularly limited, but is preferably 60% by mass to 98% by mass and more preferably 70% by mass to 95% by mass with respect to 100% by mass of a solid component in the dispersion material (combination) for configuring an active material layer.

Anode Active Material

As the anode active material, a material that can reversibly insert and discharge lithium ions is preferable, but the anode active material is not particularly limited, and examples thereof include a carbonaceous material, a metal oxide such as tin oxide or silicon oxide, a metal composite oxide, a single substance of lithium, a lithium alloy such as a lithium-aluminum alloy, and a metal that can form an alloy with lithium such as Sn or Si.

These can be used singly or 2 or more types thereof may be used together in an arbitrary combination or an arbitrary ratio. Among these, a carbonaceous material or a lithium composite oxide is preferably used, in view of reliability.

In addition, a metal composite oxide is preferable since a metal composite oxide can occlude or discharge lithium, and it is preferable that titanium and/or lithium is contained as a configurational component, in view of charging and discharging characteristics at a high current density.

The carbonaceous material that is used as the anode active material is a material that is substantially formed of carbon. Examples thereof include artificial graphite such as a petroleum pitch, natural graphite, vapor phase growth graphite, and a carbonaceous material obtained by baking various synthetic resins such as a PAN-based resin or furfuryl alcohol resin. Examples thereof further include various carbon fibers such as a PAN-based carbon fiber, a cellulose-based carbon fiber, a pitch-based carbon fiber, a vapor phase growth carbon fiber, a dehydration PVA-based carbon fiber, a lignin carbon fiber, a glass-form carbon fiber, and an active carbon fiber, mesophase microspheres, a graphite whisker, and flat plate-shaped graphite.

These carbonaceous materials may be divided into a hardly graphitizable carbon material and graphite-based carbon materials depending on a graphitizing degree. In addition, it is preferable that the carbonaceous material has surface intervals, densities, and sizes of a crystallite disclosed in JP1987-22066A (JP-S62-22066A), JP1990-6856A (JP-H2-6856A), and JP1991-45473A (JP-H3-45473A). The carbonaceous material does not have to be a single material, and a mixture of natural graphite and an artificial graphite disclosed in JP1993-90844A (JP-H5-90844A) and graphite having a coating layer disclosed in JP1994-4516A (JP-H6-4516A) can be used.

Examples of a metal oxide and a metal composite oxide which are the anode active materials used in the nonaqueous secondary battery according to the invention preferably include at least one of these. As the metal oxide and the metal composite oxide, an amorphous oxide is particularly preferable, and further a chalcogenide which is a reaction product of a metal element and an element in Group 16 in the periodic table is also preferably used. The expression “amorphous” described herein means having a broad scattering band having a peak in an area of 20° to 40° as a 20 value in X ray diffraction analysis using CuKα rays, and may have crystalline diffraction lines. The strongest intensity in crystalline diffraction lines seen at 40° to 70° as a 20 value is preferably 100 times or less a diffraction line intensity at the peak of the broad diffraction band seen at 20° to 40° as a 20 value and more preferably 5 times or less, and it is particularly preferable that the crystalline diffraction lines are not included.

Among the compound groups including amorphous oxides and chalcogenides, an amorphous oxide of a metalloid element and a chalcogenide are more preferable, and elements in Groups 13 (IIIB) to 15 (VB) of the periodic table, an oxide formed with one type of Al, Ga, Si, Sn, Ge, Pb, Sb, and Bi or 2 or more types thereof in combination, and a chalcogenide are particularly preferable. Specific examples of preferable amorphous oxides and chalcogenides preferably include Ga₂O₃, SiO, GeO, SnO, SnO₂, PbO, PbO₂, Pb₂O₃, Pb₂O₄, Pb₃O₄, Sb₂O₃, Sb₂O₄, Sb₂O₅, Bi₂O₃, Bi₂O₄, SnSiO₃, GeS, SnS, SnS₂, PbS, PbS₂, Sb₂S₃, Sb₂S₅, and SnSiS₃. In addition, these may be a composite oxide with lithium oxide, for example, Li₂SnO₂.

In the nonaqueous secondary battery according to the invention, the average particle diameter of the used anode active material is preferably 0.1 μm to 60 μm. In order to realize a predetermined particle diameter, a well-known grinding machine or a classifier is used. A mortar, a ball mill, a sand mill, a vibrating ball mill, a satellite ball mill, a planetary ball mill, a turning air flow-type jet mill, and a sieve are suitably applied. At the time of grinding, wet grinding in which water or an organic solvent such as methanol exists together may be performed, if necessary. In order to realize a desired particle diameter, it is preferable to perform classification. The classification method is not particularly limited, and a sieve, an air classifier, or the like can be used if necessary. Both a wet type and a dry type can be used for the classification.

The chemical formula of the compound that can be obtained by the baking method above can be calculated in an inductively coupled plasma (ICP) emission spectral analysis method, as an analysis method or from mass differences between particles before and after burning as a simple method.

According to the invention, examples of the anode active material that can be used together with an amorphous oxide anode active material with Sn, Si, and Ge as a center suitably include a carbon material that can occlude•discharge lithium ions or lithium metal, lithium, a lithium alloy, and metal that can form an alloy with lithium.

For a preferable embodiment, the electrolyte solution exhibits excellent characteristics in any one of a combination of a high potential anode (preferably lithium.titanium oxide, and Li metal having a potential of about 1.55 V) and a combination of a low potential anode (preferably a carbon material, a silicon containing material, Li metal having a potential of about 0.1 V). Metal that can form alloys with lithium that are continuoually being developed for realization of high capacity or a metal oxide anode (preferably, Si, Si oxide, Si/Si oxide, Sn, Sn oxide, SnBₓP_{y}O_{z}, Cu/Sn, and composites of plural types of these materials), and a battery having these types of metal or a composite of a metal oxide and a carbon material as an anode can be preferably used.

According to the invention, among these, it is preferable to use an anode active material containing at least one type selected from carbon, Si, titanium, and tin.

It is particularly preferable that the nonaqueous electrolyte solution according to the invention is used in combination with a high potential anode. The high potential anode is used in combination with the cathode material described above that can be used up to a high potential in many cases, and thus the high potential anode can appropriately deal with large capacity charging and discharging, thus exhibiting the advantages according to the preferred embodiment having the combinations set in Conditions (I) to (III) above under such conditions as described in the section of the cathode active material above.

Conductive Material

The conductive material is preferably an electrically conductive material that does not cause a chemical change in the configured secondary battery, and a well-known conductive material can be arbitrarily used. Generally, conductive materials such as natural graphite (squamous graphite, scale-shaped graphite, earthy graphite, and the like), artificial graphite, carbon black, acetylene black, Ketjen black, a carbon fiber, or metal powder (copper, nickel, aluminum, and silver (disclosed in JP1988-10148A (JP-S63-10148A), JP1988-554A (JP-S63-554A), and the like), metal fibers or a polyphenylene derivative (disclosed in JP1984-20 (JP-S59-20) and JP1984-971 (JP-S59-971)) can be included singly or in a mixture. Among these, a combination of graphite and acetylene black is particularly preferable. The addition amount of the conductive agent is preferably 11% by mass to 50% by mass and more preferably 2% by mass to 30% by mass. In the case of carbon or graphite, the addition amount thereof is particularly preferably 2% by mass to 15% by mass.

Binding Agent

Examples of the binding agent include polysaccharides, a thermoplastic resin, and a polymer having rubber elasticity. Among these, emulsions (latexes) or suspensions of starch, carboxymethyl cellulose, cellulose, diacetyl cellulose, methyl cellulose, hydroxyethyl cellulose, hydroxypropyl cellulose, sodium alginate, polyacrylic acid, sodium polyacrylate, a water-soluble polymer such as polyvinyl phenol, polyvinyl methyl ether, polyvinyl alcohol, polyvinyl pyrrolidone, polyacrylonitrile, polyacrylamide, polyhydroxy (meth)acrylate, and a styrene-maleic acid copolymer, polyvinyl chloride, polytetrafluoroethylene, polyvinylidene fluoride, a tetrafluoroethylene-hexafluoropropylene copolymer, a vinylidene fluoride-tetrafluoroethylene-hexafluoropropylene copolymer, polyethylene, polypropylene, an ethylene-propylene-diene terpolymer (EPDM), a sulfonated EPDM, a polyvinyl acetal resin, a (meth)acyrylic acid ester copolymer containing a (meth)acyrylic acid ester such as methyl methacrylate and 2-ethylhexyl acrylate, a (meth)acrylic acid ester-acrylonitrile copolymer, a polyvinyl ester copolymer containing a vinyl ester such as vinyl acetate, a styrene-butadiene copolymer, an acrylonitrile-butadiene copolymer, polybutadiene, a neoprene rubber, a fluorine rubber, poly(ethylene oxide), a polyester polyurethane resin, a polyether polyurethane resin, a polycarbonate polyurethane resin, a polyester resin, a phenolic resin, and an epoxy resin are preferable, and a polyacrylic acid ester latex, carboxymethyl cellulose, polytetrafluoroethylene, and polyvinylidene fluoride are more preferable.

As the binding agent, one kind can be used singly, or 2 or more types thereof can be used in a mixture. When the addition amount of the binding agent is excessively small, the holding strength and cohesive strength of the electrode mixture are weakened. When the addition amount of the binding agent is excessively great, the electrode volume increases, and thus the capacity per unit volume or unit mass of the electrode is lowered. Due to the above-described reasons, the addition amount of the binding agent is preferably 1% by mass to 30% by mass and more preferably 2% by mass to 10% by mass.

Filler

The electrode mixture may contain a filler. As a material forming the filler, fibrous materials that do not cause a chemical change in the secondary battery according to the invention are preferable. Generally, a fibrous filler formed from an olefin polymer such as polypropylene and polyethylene, and a fibrous filler made of glass, carbon, and the like are used. The addition amount of the filler is not particularly limited, but is preferably 0% by mass to 30% by mass in the dispersion material.

Collector

As collectors of the cathodes and anodes, an electron conductor that does not cause a chemical change in the nonaqueous electrolyte secondary battery according to the invention is preferably used. For the collector of the cathodes, in addition to aluminum, stainless steel, nickel, and titanium, a collector obtained by treating carbon, nickel, titanium, or silver on the surface of aluminum, or stainless steel is preferable. Among these, aluminum or an aluminum alloy is more preferable.

For the collector of the anodes, aluminum, copper, stainless steel, nickel, or titanium is preferable, and aluminum, copper, or a copper alloy is more preferable.

Regarding the shape of the collector, a film sheet-shaped collector is generally used, but a net-shaped material, a material formed by punching, a lath material, a porous material, a foam, a material obtained by molding a group of fibers, and the like can also be used. The thickness of the collector is not particularly limited but is preferably 1 μm to 500 μm. In addition, it is also preferable that the surface of the collector is made to be uneven by a surface treatment.

An electrode composite material of the lithium secondary battery is formed by members appropriately selected from these materials.

(Separator)

The separator that is used in the nonaqueous secondary battery according to the invention is preferably formed of a material that has mechanical strength, ion permeability, and oxidation-reduction resistance at a contact surface between the cathode and the anode for electrically insulating the cathode and the anode. As such a material, a porous polymer material, an inorganic material, an organic-inorganic hybrid material, or a glass fiber is used. It is preferable that the separator has a shutdown function for securing safety, that is, a function of interrupting the current by blocking pores at 80° C. or higher and increasing resistance, and the blocking temperature is preferably 90° C. to 180° C.

The shape of the pores of the separator is typically circular or elliptical, and the size thereof is 0.05 μm to 30 μm, and preferably 0.1 μm to 20 μm. Further, the shape of the pores may be a rod shape or an undefined shape in the same manner as when a separator is prepared using a stretching method or a phase separation method. An occupancy ratio of the pores, that is, a porosity is 20% to 90% and preferably 35% to 80%.

As the polymer material, a single material such as cellulose non-woven fabric, polyethylene, or polypropylene may be used, and a composite material of 2 or more kinds may be used. A laminate of 2 or more microporous films of which pore sizes, porosities, and pore blocking temperatures are changed is preferable.

As the inorganic material, an oxide such as alumina or silicon dioxide, a nitride such as aluminum nitride or silicon nitride, or a sulfate such as barium sulfate or calcium sulfate is used, and a material having a particulate form or a fibrous form is used. With respect to the forms of the inorganic material, a thin film-shaped material such as a non-woven fabric, a woven fabric, or a microporous film is used. As the thin film-shaped material, a material having a pore size of 0.01 μm to 1 μm and a thickness of 5 μm to 50 μm is preferably used. In addition to the above-described independent thin film-shaped material, a separator obtained by forming a composite porous layer containing particles of the inorganic material described above on a surface layer of the cathode and/or the anode by using a binding agent formed of a resin can be used. Examples thereof include a separator obtained by forming a porous layer containing alumina particles having a 90% particle diameter of less than 1 μm on both surfaces of the cathode by using a binding agent formed of a fluororesin.

(Manufacturing of Nonaqueous Secondary Battery)

As the shape of the nonaqueous secondary battery according to the invention, as described above, any shape such as a sheet shape, a rectangular shape, or a cylindrical shape can be applied. In many cases, the collectors are applied (coated) with the mixture containing the cathode active material or the anode active material, and dried and compressed for use.

Hereinafter, the configuration and preparation method of the bottomed cylindrical lithium secondary battery 100 is described with reference to FIG. 2. In a bottomed cylindrical battery, the external area with respect to a power generating element to be charged is reduced, and thus it is preferable to design the battery to cause the Joule heat generated due to the internal resistance to effectively escape to the outside at the time of charging or discharging. In addition, it is preferable to design the battery to increase a filling ratio of a material having high thermal conductivity and decrease temperature distribution in the inside portion. FIG. 2 is a diagram illustrating an example of the bottomed cylindrical lithium secondary battery 100. The battery is the bottomed cylindrical lithium secondary battery 100 in which a cathode sheet 14 and an anode sheet 16 overlapping a separator 12 interposed therebetween are wound and which is stored in an external can 18. In addition, in FIG. 2, a reference numeral 20 represents an insulating plate, a reference numeral 22 represents a sealing plate, a reference numeral 24 represents a cathode collector, a reference numeral 26 represents a gasket, a reference numeral 28 represents a pressure-sensitive valve, and a reference numeral 30 represents a current interrupting element. In the enlarged circle in the diagram, a hatched portion is changed in consideration of visibility, but the respective components correspond to those in the overall diagram with respect to reference symbols.

First, a slurry-form or paste-form anode mixture is prepared by mixing the anode active material and a material obtained by dissolving the binding agent, the filler, and the like which are optionally used in an organic solvent. The obtained anode mixture is uniformly applied to the entire region of both surfaces of a metal core as a collector, and, thereafter, an organic solvent is removed so as to form an anode mixture layer. Further, the laminate of the collector and the anode active material layer is rolled using a roll press machine or the like, and the laminate is prepared to have a predetermined thickness, so as to obtain an anode sheet (electrode sheet). At this point, application methods of respective agents, the drying of applied materials, and forming methods for cathode•anode electrodes may be performed by conventional methods.

According to this embodiment, a cylindrical battery has been described as an example, but the present invention is not limited thereto. For example, after the positive•negative electrode sheets manufactured in the method described above are overlapped with the separator interposed therebetween, the laminate may be processed into a sheet-shaped battery as it is or may be folded and inserted into a rectangle can such that the can and the sheet are electrically connected to each other, and then an electrolyte is injected thereto, and an opening is sealed using the sealing plate, thereby forming a rectangular battery.

In all the embodiments, a safety valve can be used as the sealing plate for sealing the opening. In addition, as a sealing member, in addition to the safety valve, various safety elements which are well-known in the related art may be provided. For example, as an overcurrent preventing element, a fuse, a bimetal, or a PTC element is preferably used.

In addition, in addition to the safety valve, as a countermeasure against an increase in the internal pressure of the battery can, a method of forming a slit in the battery can, a gasket cracking method, or a sealing plate cracking method, or a method of disconnecting a lead plate can be used. In addition, a protective circuit into which overcharge or overdischarge preventing provision is built may be provided in a charger or may be independently connected to a charger.

As the can or the lead plate, an electrically conductive metal or an electrically conductive alloy can be used. For example, a metal such as iron, nickel, titanium, chromium, molybdenum, copper or aluminum or an alloy thereof is preferably used.

As a welding method of a cap, a can, a sheet, or a lead plate, a well-known method (for example, DC or AC electric welding, laser welding, or ultrasonic welding) can be used. As a sealing agent for sealing the opening, a compound or a mixture which is well-known in the related art such as asphalt can be used.

[Use of Nonaqueous Secondary Battery]

Secondary batteries called lithium batteries are classified into secondary batteries (lithium ion secondary batteries) that use the occluding and discharging of lithium for the charging and discharging reaction and secondary batteries (lithium metal secondary batteries) that use the depositing and dissolving of lithium. According to the invention, the application as the lithium ion secondary battery is preferable.

Since the nonaqueous secondary battery according to the invention allows manufacture of a satisfactory secondary battery having cycle characteristics, the nonaqueous secondary battery is applied to various uses. The application embodiment is not particularly limited, but, when the non-aqueous secondary battery is applied to an electronic apparatus, examples thereof include a laptop computer, a pen-input PC, a mobile PC, an electronic book player, a mobile phone, a cord-less phone system, a pager, a handy terminal, a portable fax, a portable copying machine, a portable printer, a headphone stereo set, a video camera, a liquid crystal television, a handy cleaner, a portable CD player, a mini disc player, an electric shaver, a transceiver, an electronic organizer, an electronic calculator, a memory card, a portable tape recorder, a radio player, and a backup power supply. In addition, examples of an electronic apparatus for consumer use include an automobile, an electromotive vehicle, a motor, a lighting device, toys, a game device, a load conditioner, a clock, a strobe, a camera, and medical devices (for example, a pacemaker, a hearing aid, or a shoulder massager). Further, the nonaqueous secondary battery can be used as various batteries for use in military or aerospace applications. In addition, the nonaqueous secondary battery can be used in combination with a solar battery.

### EXAMPLES

Hereinafter, the invention is described in detail with reference to examples, but the invention is not be construed to be limited thereto.

Preparation of Electrolyte Solution

Phosphazen compound X and phosphorus-containing compound Y were added to nonaqueous solvents of Table 1 in amounts shown in the table, and LiPF₆ was added to this such that the concentration thereof become 1 M, so as to prepare electrolyte solutions for respective tests. All viscosities of the prepared electrolyte solutions at 25° C. were 5 mPa·s or less, and the moisture content thereof measured by the Karl Fischer method (JISK0113) was 20 ppm or less.

### Example 1

### Comparative Example 1

### Flame Retardancy

Flame retardancy of the prepared electrolyte solutions at 25° C. under atmospheric pressure was evaluated.

The evaluation was performed in the following test system with reference to the UL-94HB horizontal combustion test. Glass filter paper (ADVANTEC GA-100) having a width of 13 mm and a length of 110 mm was cut out, and 1.5 ml of the prepared electrolyte solution was uniformly dropped on the glass filter paper. After the glass filter paper was sufficiently soaked with the electrolyte solution, surplus electrolyte solution was wiped off, and the glass filter paper was suspended horizontally. The glass filter paper was ignited for 3 seconds at a position where a tip end of the glass filter paper was in contact with an inner flame in a butane gas burner in which the entire flame length was adjusted to 2 cm. Next, according to the behavior after being released from the flame, the presence or absence of ignition, flame quenching after the ignition, and the time taken for the flame to reach the other side from the ignition point were evaluated as follows. With respect to an electrolyte solution to which a combustion inhibitor was not added, the time taken for the flame to reach the other end from the ignition point was less than 10 seconds.

5 . . . The glass filter paper did not ignite and was incombustible.

4 . . . The glass filter paper ignited but the flame was immediately extinguished.

3 . . . The glass filter paper ignited but the flame was extinguished before the flame reached the other end.

2 . . . The time taken for the flame to reach the other end from the ignition point was 15 seconds or longer, and a combustion inhibition effect was seen but the glass filter paper did not reach a level of incombustibility or flame quenching.

1 . . . The time taken for the flame to reach the other end from the ignition point was 15 seconds or less, and the glass filter paper has no combustion inhibition effect.

TABLE 1

| | | | | | | | | | | | Discharge capacity | | |
|---|---|---|---|---|---|---|---|---|---|---|---|---|---|
| | Solvent | | Combustion inhibitors | | | | | | | | retention rate | | |
| Sample | (Volume | | X (% | | Y (% | | Condition | | | Flame | (II)/ | (III)/ | (IV)/ |
| No. | ratio) | b.p. | by mass) | b.p. | by mass) | b.p. | (I) | (II) | (III) | retardancy | (I) | (I) | (I) |
| 101 | EC(30) | 238 | PN3(1.5) | 110 | PN13(1.5) | 160 | + | | | 4 | A | B | D |
| 102 | EMC(70) | 108 | PN3(2.5) | 110 | PN13(2.5) | 160 | + | | | 5 | A | B | D |
| 103 | | | PN3(3.5) | 110 | PN13(3.5) | 160 | + | | | 5 | A | C | D |
| 104 | | | PN3(5) | 110 | PN13(5) | 160 | + | | | 5 | A | C | D |
| 105 | | | PN3(2.5) | 110 | PN15(2.5) | 194 | + | | | 4 | A | B | D |
| 106 | | | PN3(2.5) | 110 | PN16(2.5) | 213 | + | | | 3 | A | B | D |
| 107 | | | PN1(2.5) | 51 | PN9(2.5) | 142 | + | + | | 5 | A | B | D |
| 108 | | | PN2(2.5) | 86 | PN6(2.5) | 125 | + | + | | 4 | A | 13 | D |
| 109 | | | PN4(2.5) | 105 | PN11(2.5) | 156 | + | + | | 5 | A | B | D |
| 110 | | | PN1(2.5) | 51 | PN7(2.5) | 130 | + | + | | 4 | A | 13 | D |
| 111 | | | PN2(2.5) | 86 | Y1-1d(2.5) | 190 | + | + | | 3 | A | B | D |
| 112 | | | PN2(2.5) | 86 | Y1-1e(2.5) | 197 | + | + | | 3 | A | 13 | D |
| 113 | | | PN1(2.5) | 51 | PN3(2.5) | 110 | | + | | 5 | A | B | D |
| 114 | | | PN3(2.5) | 110 | PN11(2.5) | 156 | + | | | 5 | A | B | D |
| 115 | | | PN17(2.5) | 114 | PN11(2.5) | 156 | + | | | 5 | A | B | D |
| 116 | | | PN18(2.5) | 118 | PN11(2.5) | 156 | + | | | 5 | A | B | D |
| c101 | | | None | | | | | | | 1 | A | B | D |
| c102 | | | PN6(3) | 125 | | | | | | 2 | A | B | D |
| c103 | | | PN6(5) | 125 | | | | | | 3 | A | C | D |
| c104 | | | PN6(7) | 125 | | | | | | 4 | B | C | E |
| c105 | | | PN6(10) | 125 | | | | | | 5 | B | D | E |
| c106 | | | Y1-1d(10) | 190 | | | | | | 2 | B | D | E |
| c107 | | | Y1-1e(10) | 197 | | | | | | 2 | B | D | E |
| c108 | | | PN6(2.5) | 125 | PN15(2.5) | 194 | | | | 3 | A | C | D |
| c109 | | | PN6(2.5) | 125 | PN-X(2.5) | 230 | | | | 2 | A | C | D |
| c110 | | | PN6(5) | 125 | PN-X(5) | 230 | | | | 4 | B | D | E |
| c111 | | | PN2(5) | 86 | PN-X(5) | 230 | | | | 4 | B | D | E |
| c112 | | | Y-X(5) | 86 | PN6(10) | 125 | | | | 4 | B | C | D |
| 201 | EC(1) | 238 | PN3(1.5) | 110 | PN13(1.5) | 160 | + | | + | 4 | A | B | C |
| 202 | EMC(1) | 108 | PN3(2.5) | 110 | PN13(2.5) | 160 | + | | + | 5 | A | B | C |
| 203 | DMC(1) | 90 | PN3(3.5) | 110 | PN13(3.5) | 160 | + | | + | 5 | A | B | C |
| 204 | | | PN3(5) | 110 | PN13(5) | 160 | + | | + | 5 | A | B | D |
| 205 | | | PN1(2.5) | 51 | PN9(2.5) | 142 | + | + | | 5 | A | B | C |
| 206 | | | PN3(2.5) | 110 | PN6(2.5) | 125 | + | | + | 4 | A | B | C |
| 207 | | | PN3(3) | 110 | PN11(2) | 156 | + | | + | 4 | A | B | C |
| 208 | | | PN4(2.5) | 105 | PN9(2.5) | 142 | + | | + | 5 | A | B | C |
| 209 | | | PN2(2.5) | 86 | PN9(2.5) | 142 | + | + | | 5 | A | B | C |
| 210 | | | PN5(2.5) | 100 | PN14(2.5) | 185 | + | | + | 4 | A | B | C |
| 211 | | | PN3(5) | 110 | | | | | + | 5 | A | B | C |
| 212 | | | PN4(5) | 105 | | | | | + | 5 | A | B | C |
| 213 | | | PN18(6) | 118 | | | | | + | 5 | A | B | C |
| c201 | | | None | | | | | | | 1 | A | B | C |
| c202 | | | PN6(3) | 125 | | | | | | 2 | A | B | C |
| c203 | | | PN6(5) | 125 | | | | | | 3 | B | C | C |
| c204 | | | PN6(7) | 125 | | | | | | 3 | C | C | D |
| c205 | | | PN6(10) | 125 | | | | | | 4 | C | C | D |
| c206 | | | PN6(2.5) | 125 | PN15(2.5) | 194 | | | | 3 | B | C | C |
| c207 | | | PN6(2.5) | 125 | PN-X(2.5) | 230 | | | | 2 | B | C | C |
| 301 | EC(30) | 238 | PN3(1.5) | 110 | PN13(1.5) | 160 | + | | + | 3 | A | A | Frozen |
| 302 | DMC(70) | 90 | PN3(2.5) | 110 | PN13(2.5) | 160 | + | | + | 4 | A | A | |
| 303 | | | PN3(3.5) | 110 | PN13(3.5) | 160 | + | | + | 5 | A | A | |
| 304 | | | PN3(5) | 110 | PN13(5) | 160 | + | | + | 5 | A | B | |
| 305 | | | PN3(2.5) | 110 | PN13(2.5) | 160 | + | | + | 4 | A | A | |
| 306 | | | PN2(2.5) | 86 | PN13(2.5) | 160 | + | + | | 4 | A | A | |
| 307 | | | PN3(2.5) | 110 | PN15(2.5) | 194 | + | | + | 4 | A | A | |
| 308 | | | PN5(2.5) | 100 | PN14(2.5) | 185 | + | | + | 4 | A | A | |
| 309 | | | PN3(5) | 110 | | | | | + | 5 | A | A | |
| 310 | | | PN4(5) | 105 | | | | | + | 5 | A | A | |
| 311 | | | PN1(2) | 51 | PN3(3) | 110 | + | + | + | 5 | A | A | |
| 312 | | | PN17(5) | 114 | | | | | + | 5 | A | A | |
| 313 | | | PN18(5) | 118 | | | | | + | 5 | A | A | |
| c301 | | | None | | | | | | | 1 | A | A | |
| c302 | | | PN6(3) | 125 | | | | | | 2 | A | A | |
| c303 | | | PN 6(5) | 125 | | | | | | 2 | A | A | |
| c304 | | | PN6(7) | 125 | | | | | | 3 | A | A | |
| c305 | | | PN6(10) | 125 | | | | | | 3 | A | B | |
| c306 | | | PN6(2.5) | 125 | PN15(2.5) | 194 | | | | 2 | A | B | |
| c307 | | | PN6(2.5) | 125 | PN-X(2.5) | 230 | | | | 2 | A | B | |
| c308 | | | PN2(5) | 86 | PN-X(5) | 230 | | | | 4 | A | C | |
| 401 | EC(30) | 238 | PN3(1.5) | 110 | PN13(1.5) | 160 | | + | | 5 | A | C | D |
| 402 | DEC(70) | 127 | PN3(2.5) | 110 | PN13(2.5) | 160 | | + | | 5 | A | C | D |
| 403 | | | PN3(3.5) | 110 | PN13(3.5) | 160 | | + | | 5 | B | D | E |
| 404 | | | PN3(5) | 110 | PN13(5) | 160 | | + | | 5 | B | D | E |
| 405 | | | PN3(5) | 110 | PN11(2) | 156 | | + | | 5 | A | C | D |
| c401 | | | None | | | | | | | 1 | A | C | D |
| c402 | | | PN6(3) | 125 | | | | | | 3 | A | C | D |
| c403 | | | PN6(5) | 125 | | | | | | 4 | B | D | E |
| c404 | | | PN6(7) | 125 | | | | | | 5 | B | D | E |
| c405 | | | PN6(10) | 125 | | | | | | 5 | C | D | E |
| c406 | | | PN6(5) | 125 | PN-X(5) | 230 | | | | 4 | C | D | E |

Electrolyte solution No.: Numbers starting with c are comparative examples, and the others are examples of the invention
b.p.: Boiling point under 1 atmospheric pressure (° C.)
+: Ones corresponding to respective conditions
(Meanings of explanatory notes are the same in the following tables)
Solvents
EC: ethylene carbonate
EMC: ethyl methyl carbonate
DMC: dimethyl carbonate
DEC: diethyl carbonate

Compounds for Comparison

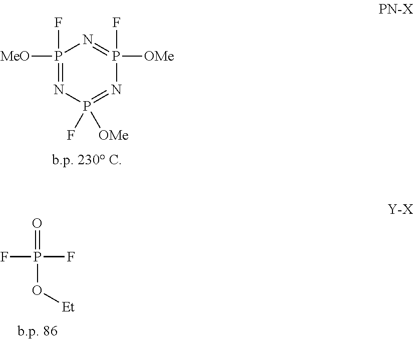 [SMILES: COP1(F)=NP(F)(OC)=NP(F)(OC)=N1 ; CCOP(=O)(F)F]

According to the results, it was found that the electrolyte solution according to the invention effectively exhibited a combustion inhibition effect with a small addition amount even if a solvent having a low boiling point was used.

### Example 2

### Comparative Example 2

### Manufacture of Battery(1)

A cathode was manufactured with active material: 85% by mass of LiNi_{1/3}Mn_{1/3}Co_{1/3}O, (NMC), Conductive assistant: 7.5% by mass of carbon black, binder: 7.5% by mass of PVDF, and an anode was manufactured with active material: 85% by mass of graphite, Conductive assistant: 7.5% by mass of carbon black, binder: 7.5% by mass of PVDF. The separator was a polypropylene porous film having a thickness of 24 μm. The cathode, the anode, and the separator above were used, vinylene carbonate was dissolved in the respective manufactured electrolyte solutions for tests at 1% by mass, and 2032-type coin batteries (1) were manufactured by using the electrolyte solutions.

### Initialization of Battery

After a 0.2C constant current was charged until a battery voltage in a thermostat bath at 30° C. became 4.3 V (positive electrode potential of 4.4 V), charging was performed until a current value at a constant voltage of a battery voltage of 4.3 V became 0.12 mA. However, the upper limit at that time was 2 hours. Subsequently, a 0.2C constant current was discharged until a battery voltage became 2.75 V in a thermostat bath at 30° C. This operation was performed twice. The following items were evaluated by using the 2032-type battery manufactured in the method described above. The results are shown in Table 1.

Here, the value “1C” refers to a current value at which a capacity of a battery is discharged or charged in 1 hour, 0.2C refer to 0.2 times this current value, 0.5C refer to 0.5 times this, and 2C refer to 2 times this. When the charging and discharging are performed with a larger current, the load becomes greater. Therefore, the capacity easily deteriorates, and the condition becomes severe.

(Charging 1)

The battery was charged with a 0.7C constant current until a battery voltage in a thermostat bath at 30° C. became 4.3 V, and charging was performed until the current value became 0.12 mA at a constant voltage of a battery voltage of 4.3 V. However, the upper limit of the time was 2 hours.

(Discharge Capacity)

Subsequently, 0.5C constant current discharging was performed in the discharging conditions of a thermostat bath at 30° C. until a positive electrode potential became 2.75 V, and Discharge capacity (I) at 30° C./0.5C was measured.

Subsequently, recharging was performed again in the conditions of Charging 1, and then 2C constant current discharging was performed in the discharging conditions of a thermostat bath at 30° C. until the battery voltage became 2.75 V, and Discharge capacity (II) at 30° C./2C was measured.

Subsequently, recharging was performed again in the conditions of Charging 1, and then 2C constant current discharging was performed in the discharging conditions of a thermostat bath at 15° C. until the battery voltage became 2.75 V, and Discharge capacity (III) at 15° C./2C was measured.

Subsequently, recharging was performed again in the conditions of Charging 1, and then 2C constant current discharging was performed in the discharging conditions of a thermostat bath at 0° C. until the battery voltage became 2.75 V, and Discharge capacity (IV) at 0° C./2C was measured.

(In addition, when EC/DMC (3/7) was used as a nonaqueous solvent, a solvent froze, and, as a result, the measurement of Discharge capacity (IV) at 0° C./2C was not performed.)

(Large Current Discharging Retention Rate)

A discharging capacity retention rate in large current discharging was calculated by the following formula.

When the value was larger, the capacity was maintained even in large current discharging, and results were satisfactory.

Discharging capacity retention rate at 30° C./2C=(II)/(I)

(Low Temperature/Large Current Discharging Retention Rate)

A discharging capacity retention rate in large current discharging in lower temperature conditions was calculated by the following formula.

When the value was greater, the capacity was maintained even in severe conditions of low temperature/large current discharging, and results were satisfactory.

Discharging capacity retention rate at 15° C./2C=(III)/(I)

Discharging capacity retention rate at 0° C./2C=(IV)/(I)

The obtained discharging capacity retention rates were evaluated as follows.

A: 0.9 or greater

B: 0.8 or greater and less than 0.9

C: 0.6 or greater and less than 0.8

D: 0.4 or greater and less than 0.6

E: 0.2 or greater and less than 0.4

F: Less than 0.2

The results are shown in Table 1, together with the results of the flame retardant test obtained in Example 1.

As seen in the results above, according to the nonaqueous electrolyte solution of the invention, it was found that a retention rate of a high discharge capacity was able to be achieved while realizing high flame retardancy. In contrast, it was found that high flame retardancy to that extent may not be realized merely by combining combustion inhibitors having different boiling points (see c108 to c111, and the like). In addition, when Conditions (I) and (II) and 2 types of combustion inhibitor were not combined and a single combustion inhibitor was used, flame retardancy was low, as a result (see 108 and c103 in comparison). It was found that, if an amount of the combustion inhibitor was increased in order to increase the flame retardancy, the maintenance of discharge capacity became difficult (see 108, c104, and c105 in comparison). That is, it was found that, the invention has effectively achieved the improvement of flame retardancy and the maintenance of battery performance, which are not compatible in the combination adjustment.

### Example 3

### Comparative Example 3

A 2032 battery was created and initialized in the same manner as in Example 2 by using the battery (cathode active material NMC) created in Example 2 and LiCoO₂ (LCO) or lithium manganate LiMn₂O₄ (LMO) as a cathode active material. The 2032 battery was charged in the conditions of Charging 1, a 0.5C constant current was discharged until the positive electrode potential became 2.75 V in the discharging conditions of a thermostat bath at 30° C., and Discharge capacity (I) at 30° C./0.5C was measured. After this battery was charged at a constant current of 0.7C until the battery voltage in a thermostat bath at 50° C. became 4.3 V, charging was continuously performed for 100 hours at a constant voltage of a battery voltage of 4.3 V. Thereafter, a 0.5C constant current was discharged until the battery voltage in a thermostat bath at 30° C. became 2.75 V, and Discharge capacity (Ia) at 30° C./0.5C after continuous charging was measured.

The discharging capacity retention rate after continuous charging was calculated by the following formula. When the value was greater, capacity deterioration was suppressed even if continuous charging was performed, and thus the results were satisfactory.

Discharging capacity retention rate after continuous charging=(Ia)/(I)

The obtained discharging capacity retention rate after continuous charging was evaluated as follows.

A: 0.9 or greater

B: 0.8 or greater and less than 0.9

C: 0.6 or greater and less than 0.8

D: 0.4 or greater and less than 0.6

E: 0.2 or greater and less than 0.4

F: Less than 0.2

TABLE 2
Continuous charge capacity retention rate

| | Combustion inhibitors | | Cathode active material | | |
|---|---|---|---|---|---|
| Sample No. | X (% by mass) | Y (% by mass) | NMC | LMO | LCO |
| 102 | PN3 (2.5) | PN13 (2.5) | A | B | C |
| 109 | PN4 (2.5) | PN11 (2.5) | A | B | C |
| 203 | PN3 (3.5) | PN13 (3.5) | A | B | C |
| 207 | PN3 (3) | PN11 (2) | A | B | C |
| 213 | PN18 (6) | | A | B | C |
| 302 | PN3 (2.5) | PN13 (2.5) | A | B | C |
| 309 | PN3 (5) | | A | B | C |
| 312 | PN17 (5) | | A | B | C |
| 313 | PN18 (5) | | A | B | C |
| c101 | None | | B | C | C |
| c103 | PN6 (5) | | B | B | C |
| c401 | PN1 (5) | | B | B | C |
| c201 | None | | B | C | C |
| c301 | None | | B | C | C |

Bolded and underlined combustion inhibitors are combustion inhibitors corresponding to Condition (III).

c401 is an example in which a test was performed by changing the combustion inhibitor in the test of c301 to PN1.

It was found that a battery in which an active material having Ni and/or Mn atoms and an electrolyte solution according to the invention were used exhibited particularly excellent results (meaningful) in the continuous charge capacity retention rate.

### Example 4

### Comparative Example 4

### Manufacture of Battery (2)

A cathode was manufactured with active material: 85% by mass of lithium nickel manganese cobalt oxide (LiNi_{1/3}Mn_{1/3}Co_{1/3}O₂), Conductive assistant: 7% by mass of carbon black, and binder: 8% by mass of PVDF, and an anode was manufactured with active material: 94% by mass of lithium titanium oxide (Li₄Ti₅O₁₂), Conductive assistant: 3% by mass of carbon black, and binder: 3% by mass of PVDF. The separator was made of polypropylene and had a thickness of 25 μm. The cathode, the anode, and the separator above were used, 1% by mass of fluoroethylene carbonate, and 1% by mass of succinonitrile was dissolved in the created electrolyte solutions for respective tests, and a 2032-type coin battery (2) was manufactured by using the electrolyte solutions.

### Initialization of Battery

After a 0.2C constant current was charged until the battery voltage became 2.85 V (positive electrode potential of 4.4 V) in a thermostat bath at 30° C., charging was performed until a current value became 0.12 mA at a constant voltage of a battery voltage of 2.85 V. However, the upper limit of the time for the constant voltage was set to 2 hours. Subsequently, 0.2C constant current discharging was performed in a thermostat bath at 30° C. until the battery voltage became 1.2 V (positive electrode potential (2.75 V)). This operation was performed twice. The 2032-type battery manufactured in the method described above was used to evaluate the items described above. The results thereof are shown in Table 1.

(Charging 2)

After the battery was charged with a 1C constant current until the battery voltage became 2.85 V in a thermostat bath at 30° C., charging was performed until the current value became 0.12 mA at a constant voltage of a positive electrode potential of 2.85 V. However, the upper limit of the time was set to 2 hours.

(Discharge Capacity)

Subsequently, 1C constant current discharging was performed until the positive electrode potential became 1.2 V (positive electrode potential (2.75 V)) in the discharging conditions of a thermostat bath at 30° C., and Discharge capacity (V) at 30° C./1C was measured.

Subsequently, recharging was performed again in the conditions of Charging 2, and then 4C constant current discharging was performed until the battery voltage in the discharging conditions of a thermostat bath at 30° C. became 1.2 V, and Discharge capacity (VI) at 30° C./4C was measured.

Subsequently, recharging was performed again in the conditions of Charging 1, and then 2C constant current discharging was performed until the battery voltage in the discharging conditions of a thermostat bath at 15° C. became 1.2 V, and Discharge capacity (VII) at 15° C./4C was measured.

Subsequently, recharging was performed again in the conditions of Charging 1, and then 2C constant current discharging was performed until the battery voltage in the discharging conditions of a thermostat bath at 0° C. became 1.2 V, and Discharge capacity (VIII) at 0° C./4C was measured.

(In addition, when EC/DMC (3/7) was used as the nonaqueous solvent, the solvent froze, and thus the measurement of Discharge capacity (VIII) at 0° C./4C was not performed.)

(Large Current Discharging Retention Rate)

The discharging capacity retention rate in large current discharging was calculated with the following formula.

When the value was larger, the capacity was maintained even in large current discharging, and results were satisfactory.

Discharging capacity retention rate at 30° C./4C=(VI)/(V)

### (Low Temperature/Large Current Discharging Retention Rate)

The discharging capacity retention rate in large current discharging under lower temperature conditions was calculated with the following formula.

When the value was larger, the capacity was maintained even in severe conditions of low temperature/large current discharging, and results were satisfactory.

Discharging capacity retention rate at 15° C./4C=(VII)/(V)

Discharging capacity retention rate at 0° C./4C=(VIII)/(V)

The obtained discharging capacity retention rates were evaluated as follows.

A: 0.9 or greater

B: 0.8 or greater and less than 0.9

C: 0.6 or greater and less than 0.8

D: 0.4 or greater and less than 0.6

E: 0.2 or greater and less than 0.4

F: Less than 0.2

The results of the flame retardant test obtained in Example 1 are shown in Table 3.

TABLE 3

| | | |
|---|---|---|
| Electrolyte | Flame | Discharge capacity retention rate |

| solution No. | retardancy | (VI)/(V) | (VII)/(V) | (VIII)/(V) |
|---|---|---|---|---|
| 101 | 4 | A | B | C |
| 102 | 5 | A | B | C |
| 103 | 5 | A | C | C |
| 104 | 5 | A | C | C |
| 105 | 4 | A | B | C |
| 106 | 3 | A | B | C |
| 107 | 5 | A | B | C |
| 108 | 4 | A | B | C |
| 109 | 5 | A | B | C |
| 110 | 4 | A | B | C |
| 111 | 3 | A | B | C |
| 112 | 3 | A | B | C |
| 113 | 5 | A | B | C |
| 114 | 5 | A | B | C |
| 115 | 5 | A | B | C |
| 116 | 5 | A | B | C |
| c101 | 1 | A | B | C |
| c102 | 2 | A | B | C |
| c103 | 3 | A | C | D |
| c104 | 4 | B | C | E |
| c105 | 5 | B | D | E |
| c106 | 2 | B | D | E |
| c107 | 2 | B | D | E |
| c108 | 3 | A | C | C |
| c109 | 2 | A | C | C |
| c110 | 4 | B | D | E |
| c111 | 4 | B | D | E |
| c112 | 4 | B | C | D |
| 201 | 4 | A | B | B |
| 202 | 5 | A | B | B |
| 203 | 5 | A | B | B |
| 204 | 5 | A | B | C |
| 205 | 5 | A | B | B |
| 206 | 4 | A | B | B |
| 207 | 4 | A | B | B |
| 208 | 5 | A | B | B |
| 209 | 5 | A | B | B |
| 210 | 4 | A | B | B |
| 211 | 5 | A | B | B |
| 212 | 5 | A | B | B |
| 213 | 5 | A | B | B |
| c201 | 1 | A | B | B |
| c202 | 2 | A | B | B |
| c203 | 3 | B | C | C |
| c204 | 3 | C | C | D |
| c205 | 4 | C | C | D |
| c206 | 3 | B | C | C |
| c207 | 2 | B | C | C |
| 301 | 3 | A | A | Frozen |
| 302 | 4 | A | A | |
| 303 | 5 | A | A | |
| 304 | 5 | A | B | |
| 305 | 4 | A | A | |
| 306 | 4 | A | A | |
| 307 | 4 | A | A | |
| 308 | 4 | A | A | |
| 309 | 5 | A | A | |
| 310 | 5 | A | A | |
| 311 | 5 | A | A | |
| 312 | 5 | A | A | |
| 313 | 5 | A | A | |
| c301 | 1 | A | A | |
| c302 | 2 | A | A | |
| c303 | 2 | A | A | |
| c304 | 3 | A | A | |
| c305 | 3 | A | B | |
| c306 | 2 | A | B | |
| c307 | 2 | A | B | |
| c308 | 4 | A | C | |
| 401 | 5 | A | C | C |
| 402 | 5 | A | C | D |
| 403 | 5 | B | D | E |
| 404 | 5 | B | D | E |
| 405 | 5 | A | C | D |
| c401 | 1 | A | C | C |
| c402 | 3 | A | C | D |
| c403 | 4 | B | D | E |
| c404 | 5 | B | D | E |
| c405 | 5 | C | D | E |
| c406 | 4 | C | D | E |

If the electrolyte solution according to the invention was used, it was possible to obtain excellent effects in that capacity deterioration could be suppressed even in severe conditions of low temperature and large current discharging and a combustion inhibition effect is compatible. Particularly, it was found that satisfactory performance was exhibited also in a secondary battery in which LTO appropriate for large current discharging was used as an anode active material.

In the example above, it was found that a battery in which the electrolyte solution according to the invention which was combined with a lithium.titanium oxide anode and a carbon anode, as an anode, and lithium nickel manganese cobalt oxide, as a cathode, to be used, exhibited excellent characteristics. According to this invention, it is assumed that the same excellent effects would be exhibited also in a battery using a cathode used at a potential of 4.5 V or greater such as lithium nickel manganate or using an Si-containing anode or a tin-containing anode which is expected to provide higher capacity than a carbon anode.

The invention has been described in detail with reference to specific embodiments, but, unless otherwise specified, any details of the descriptions are not intended to limit the invention, and it is obvious that the invention may be widely construed without departing from the gist and the scope of the invention recited in the accompanying claims.

### REFERENCE NUMERALS AND SYMBOLS

C cathode (cathode mixture)
1 cathode conductive material (collector)
2 cathode active material layer
A anode (anode mixture)
3 anode conductive material (collector)
4 anode active material layer
5 nonaqueous electrolyte solution
6 operation means
7 wire
9 separator
10 lithium ion secondary battery
12 separator
14 cathode sheet
16 anode sheet
18 external can serving as an anode
20 insulating plate
22 sealing plate
24 cathode collector
26 gasket
28 pressure-sensitive valve
30 current interrupting element
100 bottomed cylindrical lithium secondary battery

What is claimed is:

1. A nonaqueous electrolyte solution comprising:
a nonaqueous solvent;
an electrolyte; and
a combustion inhibitor,
wherein the combustion inhibitor contains a phosphazene compound, and
at least one of Conditions (I) to (III) described below is satisfied:
(I) the nonaqueous solvent contains a solvent having a boiling point of 120° C. or lower, a phosphazene compound X1 having a boiling point x1 (unit: ° C.) under 1 atmospheric pressure and a phosphorus-containing compound Y1 having a boiling point y1 (unit: ° C.) under 1 atmospheric pressure are at least used as combustion inhibitors, and Formula (i) below is satisfied with respect to the boiling points x1 and y1 of the combustion inhibitors,
x1≦120<y1≦220 (i)
(II) a phosphazene compound X2 having a boiling point x2 (unit: ° C.) under 1 atmospheric pressure and a phosphorus-containing compound Y2 having a boiling point y2 (unit: ° C.) under 1 atmospheric pressure are at least used as combustion inhibitors, and Formula (ii) below is satisfied with respect to the boiling points x2 and y2 of the combustion inhibitors and a boiling point a (unit: ° C.) of a solvent A having the lowest boiling point among nonaqueous solvents under 1 atmospheric pressure,
x2≦a<y2≦a+90 (ii)
(III) the nonaqueous solvent contains 20% by volume to 80% by volume of a solvent having a boiling point of 100° C. or lower with respect to all the nonaqueous solvent and contains 1% by mass to 20% by mass of a combustion inhibitor X3 expressed by Formula (X3) below with respect to all the electrolyte solution, 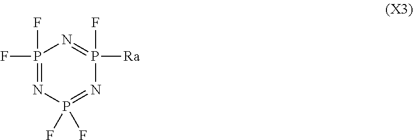
(Ra represents a substituent containing carbon atoms and the number of C—H bonds is 3 or less).

2. The nonaqueous electrolyte solution according to claim 1,
wherein each of the combustion inhibitors Y1 and Y2 is independently selected from a phosphoric acid ester compound, a phosphoric acid amide compound, and a phosphazene compound.

3. The nonaqueous electrolyte solution according to claim 1,
wherein each of the combustion inhibitors X1, X2, X3, Y1, and Y2 independently represents a cyclic phosphazene compound.

4. The nonaqueous electrolyte solution according to claim 1,
wherein each of Y1 and Y2 independently represents a cyclic phosphazene compound having an amino group.

5. The nonaqueous electrolyte solution according to claim 1,
wherein the nonaqueous solvent contains 20% by volume to 80% by volume of dimethyl carbonate and/or ethyl methyl carbonate with respect to all the solvent.

6. The nonaqueous electrolyte solution according to claim 1,
wherein the nonaqueous solvent contains 20% by volume to 80% by volume of dimethyl carbonate with respect to all of a solvent.

7. The nonaqueous electrolyte solution according to claim 1,
wherein each of at least one of the combustion inhibitors X1, X2, X3, Y1, and Y2 independently represents a cyclic phosphazene compound expressed by Formula (F1) below.

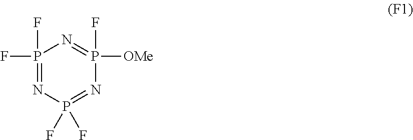 [SMILES: COP1(F)=NP(F)(F)=NP(F)(F)=N1]

8. The nonaqueous electrolyte solution according to claim 1,
wherein the electrolyte solution further contains at least one selected from an aromatic compound (A), a halogen-containing compound (B), a polymerizable compound (C), a phosphorus-containing compound (D), a sulfur-containing compound (E), a silicon-containing compound (F), a nitrile compound (G), a metal complex compound (H), and an imide compound (I).

9. A nonaqueous secondary battery comprising:
a cathode;
an anode; and
the nonaqueous electrolyte solution according to claim 1.

10. The nonaqueous secondary battery according to claim 9,
wherein an active material of the cathode contains Ni and/or Mn atoms.

11. The nonaqueous secondary battery according to claim 9,
wherein an active material of the anode is one selected from carbon, Si, titanium, and tin.

12. A method of using the secondary battery according to claim 9 for charging and discharging,
wherein the secondary battery is used at a positive electrode potential (based on Li/Li⁺) of 4.3 V or greater.
